(19) United States
(12) Patent Application Publication
(10) Pub. No.: US 2013/0018121 A1
(43) Pub. Date: Jan. 17, 2013

(54) COMPOSITION COMPRISING STABLE POLYOL MIXTURES

(71) Applicants: René NAGELSDIEK, Dinslaken (DE); Bernd Göbelt, Wesel (DE); Ralf Hoffmann, Wesel (DE); Jürgen Omeis, Dorsten-Lembeck (DE); Dorothée Greefrath, Muelheim an der Ruhr (DE); Martin Muth, Bottrop (DE)

(72) Inventors: René NAGELSDIEK, Dinslaken (DE); Bernd Göbelt, Wesel (DE); Ralf Hoffmann, Wesel (DE); Jürgen Omeis, Dorsten-Lembeck (DE); Dorothée Greefrath, Muelheim an der Ruhr (DE); Martin Muth, Bottrop (DE)

(73) Assignee: BYK-CHEMIE GMBH, Wesel (DE)

(21) Appl. No.: 13/495,552

(22) Filed: Jun. 13, 2012

Related U.S. Application Data
(63) Continuation of application No. PCT/EP2010/007671, filed on Dec. 16, 2010.

(30) Foreign Application Priority Data
Dec. 22, 2009 (EP) 09015857.7

(51) Int. Cl. C08G 18/32; C08J 9/00; C09K 3/00

(52) U.S. Cl. 521/170; 252/183.12; 528/85

(57) ABSTRACT

Single-phase, liquid compositions, comprising at least two isocyanate-reactive polyol components that are incompatible with each other and, as a mediator additive, at least one copolymer that prevents or delays the separation of the polyol components and that is composed of certain structural units, of which certain structural units have no acidic functional groups and certain structural units have at least one acidic functional group and said structural units are optionally reacted at least partially with at least one preferably organic compound having at least one basic group to produce salt, and to the use thereof to produce polyurethanes or corresponding polyurethane items.

This application is a Continuation of PCT/EP2010/085775 filed Dec. 16, 2010, which claims priority to European application 0901587.7 filed 22 Dec. 2009.

The present invention relates to monophasic, liquid compositions comprising at least two mutually incompatible isocyanate-reactive polyol components and, as compatibilizer additive agent, at least one copolymer which prevents/retards separation between the polyol components and which is constructed of certain, hereinafter recited structural units, of which certain structural units have no acidic functional groups and certain structural units have at least one acidic functional group and these are optionally at least partly salted with at least one, preferably organic compound having at least one basic group, and also to their use for production of polyurethanes and of corresponding polyurethane articles.

### BACKGROUND OF THE INVENTION

Polyurethanes are members of that class of materials of construction which are widely used in a wide variety of forms. They can be used in the form of rigid or flexible foams or in compact form in coatings, adhesives, sealants or elastomers (CASE applications). To ensure that the polyurethane used has the best possible performance profile required for the particular application, careful selection of starting components is required.

Polyurethanes are produced by reaction of polyols with polyisocyanates. While the selection of polyisocyanates available on a large industrial scale is limited, there are a multiplicity of polyols which can be used. These range from polyether polyols to polyester polyols and hydroxyl-functional polybutadienes to low molecular weight polyols used as chain extenders or chain crosslinkers for example.

Typically, a polyurethane is produced by reacting not just one specific polyol with polyisocyanates, but a mixture of various polyols, which can be of low or comparatively high molecular weight. In many cases, a mixture of polyols used is not stable, but tends to phase separation over time at least. This separation is caused for example by different molecular weights, differing monomeric composition, differing polarity and/or a differing structural arrangement such as, for example, a random or blockwise arrangement or a linear or branched structure of the polyols.

It is further known that the separation tendency is amplified in the presence of certain substances such as water for example. Separation can also be caused or amplified by the use of additives and/or auxiliary agents, or by the presence of more than 2 polyols.

Irrespective of its causes, the tendency to separate leads to diverse problems with the handling and processing of such polyol mixtures. Thus, the storage or transportation of such polyol mixtures or mixing with auxiliary agents even for short periods is in many cases not possible because of the separation tendency between the polyols. Therefore, before such polyol mixtures can be processed, the polymer components have to be mixed again to ensure homogeneous dispersion of polyol components. This requires the polyurethane producer to invest in mixing equipment which, moreover, leads to increased energy consumption. In addition, there is a risk that insufficient mixing of polyol components causes that the polyurethane produced therefrom will not have the desired performance profile. Therefore, there has been no shortage of attempts to at least improve this separation problem of polyol components.

One possible way to counteract the separation of incompatible polyol components considered in the prior art, for example U.S. Pat. No. 4,312,973, is to modify the structure of incompatible polyol components such that they remain mixed with each other to a sufficiently stable extent.

Since, however, modifying the polyol components ultimately also risks modifying the performance profile of polyurethanes produced therefrom, this solution of the separation problem is in many cases not applicable. In addition, polyurethane producers are mostly not producers of polyol components used, and so are forced to achieve the desired polyurethane performance profile using polyol components available in the marketplace.

A further attempt to solve the separation problem of incompatible polyol components in the prior art is to use a component that improves compatibility between the incompatible polyol components by at least slowing down the separation tendency between the incompatible polyol components.

In U.S. Pat. No. 4,125,505 is disclosed that polyalkylene oxides having a certain arrangement as one of the polyol components can be improved in their compatibility with an inherently incompatible chain extender, like a low molecular weight polyol, by means of particulated polymers formed from unsaturated monomers such as, for example, styrene-acrylonitrile copolymers. The disadvantages for the polyurethane producer are that the dispersed particles of polymer can sediment out of mixtures, if not used directly, or have an unintended influence on the mechanical properties of the polyurethanes produced therefrom.

In U.S. Pat. No. 5,344,584 is proposed admixing a mixture of two isocyanate-reactive compounds that are normally not miscible with each other with a surface-active compound which, as carboxylic ester or carboxamide, has acidic groups. The polycarboxylic ester preferably derives from a hydroxycarboxylic acid or from a ring-opened lactone. Adding the surface-active compound to the inherently incompatible polyol components does improve compatibility, but not always to the desired extent. In addition, these polycarboxylic esters are also not universally applicable because of the possible reactivity of their acidic groups.

Limitations are also likely with the use, disclosed in U.S. Pat. No. 4,673,696, of ethylenically unsaturated esterols as compatibilizers between short-chain and long-chain, isocyanate-reactive polyol components which are inherently incompatible with each other. This is particularly because these mixtures can only be used to produce certain polyurethanes where the use of ethylenically unsaturated esterols is unlikely to result in unwanted by-reactions. These compatibilizers are again not always able to provide a compatibility improvement to the desired extent.

DE 10 2008 000 243 describes the use of certain urethane and urea group-containing polyethers as agents for compatibilizing polyol compositions. These compounds are again not always able to provide a compatibility improvement to the desired extent.

DE 23 41 294 describes the use of surface-active inorganic materials for compatibility improvement of a polyol mixture. These solid admixture agents harbor the risk of sedimentation. Moreover, the preferred materials used therein, such as asbestos, constitute an appreciable health risk.

US 2007/238800 describes alkylphenol ethoxylates useful as admixture agents for polyol formulations based on specific plant oil polyols. These emulsifiers not only have to be viewed critically with regard to their health-damaging and ecotoxic properties, but also, in many cases, do not offer adequate stabilizing properties for polyol mixtures.

U.S. Pat. No. 7,223,890 B2 describes an isocyanate-reactive mixture which in addition to water and a DMC-catalyzed alkoxylated polyol contains a compound which has ethylene oxide units and improves the water compatibility of the mixture. Examples mentioned of these compounds include block copolymers of ethylene oxide and propylene oxide.

Nothing in the disclosure of said US patent points to any compatibility improvement of mutually incompatible polyols.

The disclosure of US 2006/0189704 is concerned with the compatibility improvement, i.e., prevention of phase separation, of compositions containing at least a polyol, water and an alkoxylate with three or more hydroxyl groups of compounds with reactive hydrogen, for example glycerol, as compatibility-improving agents. The presence of these compatibility-improving agents prevents the separation of water and polyol in storage.

US 2008/009209 describes a curable composition containing a polyacid, one or more polyols and also one or more reactive water-repellant agents. Polyalkoxylates of alkyl- and alkenylamines are among the recited examples of water-repellant compounds.

These known water-repellant, curable compositions are used for coating glass fibers or mineral wool, while a specific range is recommended for the ratio of carboxyl groups to OH groups in the mixture. Compatibilization of polyol mixtures forms no part of the subject matter of this published US application.

U.S. Pat. No. 5,668,187 B2 discloses the production of rigid polyurethane foam wherein the blowing agent comprises an aqueous emulsion containing a copolymer of various unsaturated monomers in emulsified form being directly added, as further reaction component, in the reaction of polyol with polyisocyanate.

It is an object of the present invention to remedy the disadvantages of the prior art and to suppress the separation tendency of isocyanate-reactive polyol components, which are inherently incompatible or become incompatible, essentially caused by their different construction, polarity and/or molecular weight, as far as possible until their further reaction into polyurethanes.

### SUMMARY OF THE INVENTION

This object is achieved by providing the liquid composition of the present invention, which is storage-stable monophasically and comprises
(1) 1 to 99 wt % of an isocyanate-reactive polyol component,
(2) 1 to 99 wt % of at least one further isocyanate-reactive polyol component, this polyol component being incompatible with the polyol component (1),
(3) 0 to 45 wt % of at least one further liquid component from the group of additives and/or auxiliary agents, and
(4) as compatibilizer additive agent from 0.1 to 10 wt % of at least one copolymer effecting that the polyol components (1) and (2) and the optionally present component (3) are monophasical,
wherein the wt % of components (1) to (4) are all based on 100 wt % of the composition and the composition must always produce 100 wt % and the sum total of components (1) and (2) must always amount to at least 50 wt % of the composition, and
wherein the copolymer (4) may comprise the following structural units I to VII and is built of at least one of the structural units I to III, which contain no acidic functional groups, and of at least one of the structural units IV to VII, which contain at least one acidic functional group, and the copolymer (4) has a molar ratio of acidic functional groups to optionally present N-containing, basic groups and/or corresponding quaternized groups of the unsalted copolymer (4) of at least 5:1.

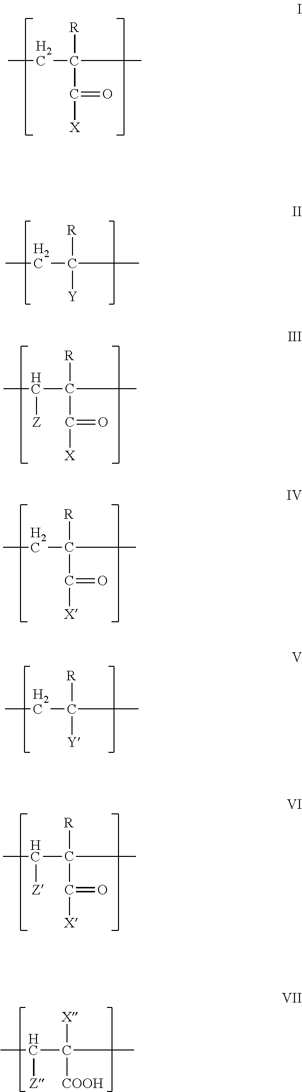

where
R, which is the same or different in each occurrence, represents hydrogen or an optionally branched alkyl moiety of 1-5 carbon atoms,
X, which is the same or different in each occurrence, represents an —OR′ group, an

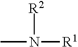

group or an —NH₂ group, where
R¹, which is the same or different in each occurrence, represents an optionally branched alkyl moiety of 1-12 carbon atoms, an optionally branched alkenyl moiety of 1-12 carbon atoms, which optionally may contain functional groups with the exception of acidic functional groups, a cycloalkyl moiety of 4-10 carbon atoms, an aromatic moiety of 6-20 carbon atoms, wherein each of these moieties may optionally also be substituted, but does not contain an acidic functional group, a polyether moiety or a polyester moiety or a polyether/polyester moiety, which each does not contain any acidic groups,
R², which is the same or different in each occurrence, represents hydrogen or has the meaning of R¹.
Y represents an optionally substituted, aromatic moiety of 4-12 carbon atoms which optionally has at least one heteroatom as ring member, a lactam moiety of 4-8 carbon atoms, a polyether or polyester moiety attached via an —O— or

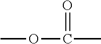

bridge, or an

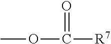

group, where
R⁷ represents an alkyl moiety of 1-6 carbon atoms or a cycloalkyl moiety of 4-10 carbon atoms, wherein each of these moieties may be substituted with functional groups with the exception of acidic functional groups,
Z represents a —COOR¹ group, where R¹ is as defined above, or
Z combines with the

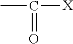

group where X is an

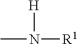

or —NH₂ group to form a cyclic imide group whose nitrogen may optionally be substituted with an R¹ moiety as defined above,
X′, which is the same or different in each occurrence, represents an —OH group which is optionally present as a group salted by salting with one of the hereinafter recited, preferably organic, basic compounds (5) used for salting, or represents an —OR¹¹ group or a

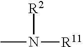

group, where
R¹¹, which is the same or different in each occurrence, represents an optionally branched alkyl moiety of 1-20 carbon atoms, an optionally branched alkenyl moiety of 1-20 carbon atoms, a cycloalkyl moiety of 4-10 carbon atoms, an aromatic moiety, wherein each of these moieties in addition to at least one of the hereinafter recited acid groups may optionally be further substituted,
   and R² is as defined above,
   a polyether moiety, a polyester moiety or a polyether/polyester moiety,
   wherein each of these moieties contains at least one carboxylic, sulfonic, phosphonic and/or phosphoric acid group which optionally by salting with one of the hereinafter recited, preferably organic, basic compounds (5) used for salting is present as salted group;
   Y′ represents a phosphonic acid group, phosphoric acid group, represents a linear or branched aliphatic radical of 1 to 8 carbon atoms, represents an aromatic radical of at least 5 ring members which optionally contains heteroatoms, or represents a saturated or unsaturated cycloaliphatic radical of at least 5 ring members which optionally contains heteroatoms, wherein each of these radicals contains at least one carboxylic, sulfonic, phosphonic and/or phosphoric acid group,
   wherein the acidic group is optionally through salting with one of the hereinafter recited, preferably organic, basic compounds (5) used for salting present as salted group, or
represents a polyether or polyester moiety attached via an —O— or

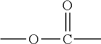

bridge or a

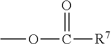

group, where
R⁷ represents an optionally substituted branched or unbranched alkyl moiety of 1-6 carbon atoms or an optionally substituted cycloalkyl moiety of 4-10 carbon atoms, wherein each of the polyether or polyester moieties or each of the R⁷ moieties contains at least one carboxylic, sulfonic, phosphonic and/or phosphoric acid group which optionally by salting with one of the hereinafter recited, preferably organic, basic compounds (5) used for salting is present as salted group;
Z′, which is the same as or different from X′, represents a grouping having the meaning of X′, represents a —COOH group or represents a —COOR¹ group or a —COOR¹¹ group, where R¹ and —R¹¹, which are the same or different, are each as defined before,
Z″ represents hydrogen, an optionally branched alkyl moiety of 1-10 carbon atoms or an aryl moiety of 6-20 carbon atoms, wherein each of these moieties may be substituted with a carboxyl group,
X″, which is the same as or different from Z″, has the meaning of Z″, in which case either only Z″ or X″ can have the meaning of hydrogen,
wherein the structural units IV to VII are optionally at least partly present in salted form by reaction with at least one preferably oligomeric, preferably organic compound (5) having at least one basic group as salting compound.

As noted, the structural units I-III do not contain any acidic functional groups, the structural units IV to VII each contain at least one acidic group and whereby in the unsalted copolymer (4) the molar ratio of acidic functional groups to optionally present N-containing, basic groups and/or corresponding quaternized groups of the unsalted copolymer (4) is at least 5:1, preferably at least 10:1 and more preferably at least 20:1.

In a particularly preferred embodiment, the unsalted copolymer (4) does not contain any N-containing, basic groups and/or corresponding quaternized groups.

### DETAILED DESCRIPTION

The copolymer (4) used as compatibilizer additive may preferably comprise the structural units I-VII in which
R, which is the same or different in each occurrence, represents hydrogen, methyl or ethyl,
X, which is the same or different in each occurrence, represents an —NH—R′ group or an —OR′ group, where R′, which is the same or different, represents an optionally branched alkyl moiety of 1 to 8 carbon atoms, a benzyl moiety, an optionally branched alkylene moiety of 1 to 8 carbon atoms, optionally substituted with an OH group, which is preferably present as end group, or a polyalkylene oxide moiety,
Y represents an optionally substituted phenyl, naphthyl or pyrrolidone moiety, an ε-caprolactam moiety, a polyalkylene oxide moiety attached via an —O— bridge or an acetate moiety, wherein each of these moieties does not contain any acidic functional groups,
Z represents a —COOR¹ group, where R¹, which is the same or different in each occurrence, is as defined above, or
Z combines with the

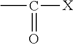

group where X is an

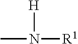

group to form a cyclic imide grouping whose nitrogen is substituted with an R¹ moiety, which is the same or different, as defined above,
X′, which may be the same or different in each occurrence, represents an —OH group which is optionally present as a group salted by salting with at least one of the hereinafter recited, preferably organic, basic compounds (5), or
represents an —OR¹¹ group,
where
R¹¹ represents an optionally branched alkyl moiety of 1-20 carbon atoms, an optionally branched alkenyl moiety or alkenyl moiety of 1 to 16 carbon atoms, which contains at least one carboxylic, sulfonic, phosphonic and/or phosphoric acid group which optionally through salting with at least one of the hereinafter recited, preferably organic, basic compounds (5) is present as salted group,
   Y′ represents a phosphonic acid group, phosphoric acid group, represents a linear or branched aliphatic radical of 1 to 8 carbon atoms or aromatic radical of at least 6 carbon atoms, wherein each radical contains at least one carboxylic, sulfonic, phosphonic and/or phosphoric acid group which optionally through salting with at least one of the hereinafter recited, preferably organic, basic compounds (5) is present as salted group,
Z′, which is the same as or different from X′, represents a grouping having the meaning of X′, represents a —COOH group or represents a —COOR¹ group, where R¹, which is the same or different, is as defined above,
Z″ represents hydrogen, an optionally branched alkyl moiety of 1-6 carbon atoms or an aryl moiety of 6-10 carbon atoms, wherein each of the moieties may be substituted with a carboxyl group,
X″, which is the same as or different from Z″, has the meaning of Z″, in which case either only Z″ or only X″ can have the meaning of hydrogen,
   wherein the structural units IV to VII may be optionally at least partly present in salted form by reaction with at least one preferably oligomeric, preferably organic compound (5) having at least one basic group as salting compound and the above-recited conditions concerning the proportions of the individual components in the composition of the present invention and the molar ratios of acidic functional groups to optionally present N-containing, basic groups in copolymer (4) are taken into account.

For the purposes of the present invention, an incompatible mixture of polyols is deemed to be a mixture of at least two inherently incompatible polyols, or a mixture of polyols which become incompatible at least on addition of at least one additive and/or auxiliary agent, which in either case on storage at a temperature of 20° C. becomes a visible (to the naked eye) two-phase formation even after it has been mixed with customary mixing equipment to a monophase mixture.

The compatibilizer additive (4) is preferably added to a multi-phase mixture comprising at least two polyols (1) and (2) in such amounts that a storage-stable monophasic composition of the present invention is achieved on mixing with customary mixing means. The compatibilizer additive is preferably added in such an amount that the storage-stable monophasicness of the monophasic composition thus obtained is ensured to be at least 50% longer, but at least for 6 hours longer compared with the corresponding composition without addition of compatibilizer additive (4).

The compatibilizer additive (4) is more preferably added in such an amount that the storage-stable monophasicness of the monophasic composition thus obtained is ensured to be at least 100% longer, but at least for 12 hours longer compared with the corresponding composition without addition of compatibilizer additive (4).

The compatibilizer additive (4) is most preferably added in such an amount that the storage-stable monophasicness of the monophasic composition thus obtained is ensured to be at least 200% longer, but at least for 24 hours longer compared with the corresponding composition without addition of compatibilizer additive (4). It is especially preferable for the compatibilizer additive (4) to be added in such an amount that the monophasicness of the monophasic composition thus obtained is ensured until its reactive conversion into a polyurethane.

The copolymer used as compatibilizer additive (4) may have a random, gradientlike or blocklike arrangement of copolymerized structural units which optionally comprises comb structures. Compared with a random copolymer, such structures are subsumed under the term “structured copolymers”.

In a preferred embodiment, the compatibilizer additive (4) is a structured copolymer.

Structured copolymers are linear block copolymers, gradientlike copolymers, branched/star-shaped block copolymers and comb copolymers.

Gradientlike copolymers of the copolymers which are used according to the present invention are copolymers in which, along the polymer chains, the concentration of structural units of a particular ethylenically unsaturated monomer or of structural units of a mixture of ethylenically unsaturated monomers decreases continuously and the concentration of structural units of a different ethylenically saturated monomer or of structural units of a mixture of different ethylenically unsaturated monomers increases.

Disclosure in EP 1 416 019 and WO 01/44389 and also Macromolecules 2004, 37, 966, Macromolecular Reaction Engineering 2009, 3, 148, Polymer 2008, 49, 1567 and Biomacromolecules 2003, 4, 1386 are referenced as exemplary of gradientlike copolymers.

Block copolymers used according to the present invention are copolymers obtained by adding at least two different ethylenically unsaturated monomers, two different mixtures of ethylenically unsaturated monomers or by adding an ethylenically unsaturated monomer and a mixture of ethylenically unsaturated monomers at different times in the practice of a controlled polymerization. All the ethylenically unsaturated monomers or mixtures of ethylenically unsaturated monomers used in the polymerization may be added or dosed in portions to the reaction batch during the practice of the polymerization, or an ethylenically unsaturated monomer or a mixture of ethylenically unsaturated monomers is initially charged at the start of the reaction and the other ethylenically unsaturated monomers or mixtures of ethylenically unsaturated monomers are added. At the time of adding the further ethylenically unsaturated monomer or the mixture of ethylenically unsaturated monomers or adding ethylenically unsaturated monomers in multiple installments, the ethylenically unsaturated monomers initially charged at the start of the polymerization or those already added up to this point in time can be either already completely reacted, or still be partly unpolymerized. As a result of such a polymerization, block copolymers have at least one abrupt or else gradientlike transition in their structural units along the polymer chain, said transition marking the boundary between the individual blocks.

Such block copolymer structures which may preferably be used are for example AB diblock copolymers, ABA triblock copolymers or ABC triblock copolymers. Examples of producing such block copolymer structures are found in U.S. Pat. No. 6,849,679, U.S. Pat. No. 4,656,226, U.S. Pat. No. 4,755,563, U.S. Pat. No. 5,085,698, U.S. Pat. No. 5,160,372, U.S. Pat. No. 5,219,945, U.S. Pat. No. 5,221,334, U.S. Pat. No. 5,272,201, U.S. Pat. No. 5,519,085, U.S. Pat. No. 5,859,113, U.S. Pat. No. 6,306,994, U.S. Pat. No. 6,316,564, U.S. Pat. No. 6,413,306, EP 1416019, EP 1803753, WO 01/44389 and WO 03/046029.

Block copolymers which are preferably used according to the present invention contain blocks having a minimum number of 3 structural units per block.

The minimum number of structural units per block is preferably 3, more preferably 5 and most preferably 8.

Each of the blocks may contain the same structural units but each in different numbers, or is constructed of different structural units.

In one preferred embodiment, the compatibilizer additive (4) has a block structure of the type A-B, A-B-A, B-A-B, A-B-C and/or A-C-B, in which the A, B and C blocks represent a differing composition of structural units, wherein the blocks A, B and C differ by their respective composition of structural units I-VII and the proportion of structural units IV-VII in two adjacent blocks differs from each other by at least wt %, based on the total amount of the respective block.

Particular preference is given to block structures in which

block A contains from 0 to 25 wt % of at least one of structural units IV-VII, optionally at least partly salted,
block B contains from 50 wt % to 100 wt % of at least one of structural units IV-VII, optionally at least partly salted,
and block C contains from 0 to 75 wt % of at least one of structural units IV-VII, optionally at least partly salted,
wherein the wt % given for structural units IV-VII are based on their acidic, i.e., unsalted form.

A very particularly preferred embodiment is characterized in that

block A contains from 0 to 10 wt % of at least one of structural units IV-VII, optionally at least partly salted,
block B contains from 75 wt % to 100 wt % of at least one of structural units IV-VII, optionally at least partly salted,
and block C contains from 0 to 50 wt % of at least one of structural units IV-VII, optionally at least partly salted,
wherein the wt % given for structural units IV-VI are based on their acidic, i.e., unsalted form.

In a preferred overall composition for the copolymer (4) used as compatibilizer additive, the proportion of structural units IV-VII in the unsalted state is from 5 to 95 wt %, more preferably from 15 to 60 wt % and even more preferably from 20 to 45 wt %, the proportion of structural units I-III is from 95 to 5 wt %, more preferably from 60 to 15 wt % and even more preferably from 45 to 20 wt %, and the proportion of optionally present free-radically or ionically copolymerizable α,β-unsaturated monomers is from 0 to 10 wt %, more preferably from 0 to 5 wt % and even more preferably 0 wt %, all based on 100 wt % of copolymer (4), and wherein the proportions must always sum to 100 wt %.

In a preferred embodiment of the invention, the copolymer (4) used as compatibilizer additive is present in a state in which at least 5 mol %, preferably at least 20 mol %, more preferably at least 60 mol % and even more preferably at least 80 mol % of structural units IV-VII having acidic functional groups have been salted with a basic, preferably nitrogenous, preferably organic compound which optionally is at least oligomeric.

The number average molecular weight Mₙ of the copolymers used according to the present invention is in their unsalted form preferably in the range from 600 to 250 000 g/mol, more preferably in the range from 1000 to 25 000 g/mol and even more preferably in the range from 1500 to 10 000 g/mol. Molecular weights are determined using gel permeation chromatography (GPC), as more particularly elucidated in the examples.

The copolymers used according to the present invention are notable for having at least one of structural units IV to VII, which contains a deprotonatable acidic group as a result of polymerization of a corresponding ethylenically unsaturated monomer, or where such a deprotonatable group was incorporated in the molecule through chain-analogous reaction.

A deprotonatable acidic group for the purposes of the present invention is a group in which an acidic hydrogen atom can react in the presence of a base to form an anion, although this reaction can also proceed reversibly as the case may be. This is diagrammatically illustrated using the following reactions in which B represents a base and BH³ represents the acid corresponding to the base:

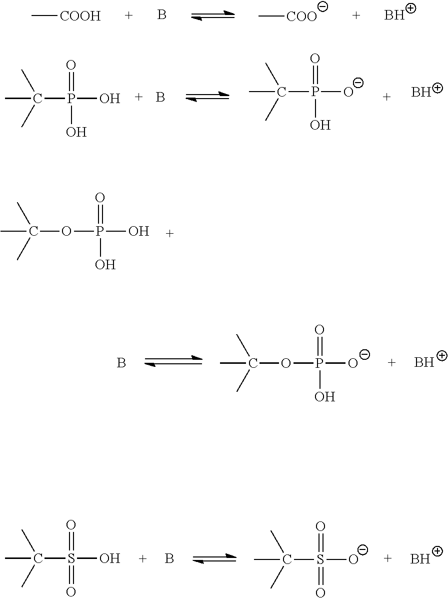

Examples of compounds having deprotonatable groups are for instance compounds that have carboxylic acid, phosphonic acid, phosphoric acid and/or sulfonic acid groups.

Particular preference for use as monomers is given to monoethylenically unsaturated aliphatic compounds having carboxylic acid or phosphoric acid groups.

The structural units IV-VII of the copolymers used according to the present invention may preferably derive from ethylenically unsaturated, preferably aliphatic monomers that have acidic groups, and/or vinyl-containing, preferably aromatic cycles having at least one deprotonatable group as substituted, functional group.

Preference for use as ethylenically unsaturated monomers having at least one acidic group and having at least one carboxylic acid, phosphonic acid, phosphoric acid and/or sulfonic acid group may be given to at least one monomer selected from the group comprising (meth)acrylic acid, carboxyethyl(meth)acrylate, itaconic acid, fumaric acid, maleic acid, citraconic acid, crotonic acid, cinnamic acid, vinylsulfonic acid, 2-methyl-2-[(1-oxo-2-propenyl)amino]-1-propanesulfonic acid, styrenesulfonic acid, vinylbenzenesulfonic acid, vinylphosphonic acid, vinylphosphoric acid, 2-(meth)-acryloyloxyethyl phosphate, 3-(meth)acryloyloxypropyl phosphate, 4-(meth)acryloyloxybutyl phosphate, 4-(2-methacryloyloxyethyl)trimellic acid, 10-methacryloyloxydecyl dihydrogenphosphate, ethyl-2-[4-(dihydroxyphosphoryl)-2-oxabutyl]acrylates, 2-[4-(dihydroxyphosphoryl)-2-oxabutyl]acrylic acid, 2,4,6-trimethylphenyl 2-[4-(dihydroxyphosphoryl)-2-oxabutyl]acrylate, unsaturated fatty acids and the acid-functional monomers with a polymerizable double bond which are mentioned in EP 1674067 A1.

Monomers having more than one acidic functional group can also be used in the form of their partial, acidic esters.

Very particular preference is given to α,β-unsaturated carboxylic acids such as (meth)acrylic acid, acidic (meth)acrylic esters, maleic acid and its acidic derivatives such as partial esters, partial amides.

The acid-functional structural units IV-VII of the copolymers used according to the present invention are also obtainable by modifying structural units after their production e.g. by polymerization of OH-containing ethylenically unsaturated monomers such as hydroxyalkyl(meth)acrylates for example, and subsequent reaction of the OH groups with corresponding, reactive cyclic carboxylic anhydrides to form their acidic monoesters, or by reacting the OH groups with sultones or by reacting the OH groups with phosphorylating agents or by carboxymethylation.

Alternatively, acidic functional groups in copolymers (4) can also be produced by hydrolyzing structural units of copolymers (4) used according to the present invention that are derived for example from (meth)acrylic esters and amides, from maleic esters or its anhydride or from silyl-protected unsaturated carboxylic acids such as trimethylsilyl methacrylate for example. This procedure commends itself for example when the polymerization method used to produce the copolymers (4) is hindered by the presence of acidic monomers as in the case of anionic polymerization for example.

The structural units I-III of the copolymers used according to the present invention are preferably obtainable using at least one ethylenically unsaturated monomer selected from the group comprising alkyl (meth)acrylates of straight-chain, branched or cycloaliphatic monoalcohols of 1 to 22 carbon atoms, preferably methyl(meth)acrylate, ethyl(meth)acrylate, n-butyl(meth)acrylate, i-butyl(meth)acrylate, t-butyl(meth)acrylate, lauryl(meth)acrylate, 2-ethylhexyl(meth)acrylate, stearyl(meth)acrylate, tridecyl(meth)acrylate, cyclohexyl(meth)acrylate, isobornyl(meth)acrylate, allyl(meth)acrylate, and t-butyl(meth)acrylate; aryl(meth)acrylates, preferably optionally up to tetrasubstituted benzyl(meth)acrylate and phenyl(meth)acrylate, such as 4-nitrophenyl methacrylate; hydroxyalkyl(meth)acrylates of straight-chain, branched or cycloaliphatic diols of 2 to 36 carbon atoms, for example 3-hydroxypropyl methacrylate, 3,4-dihydroxybutyl monomethacrylate, 2-hydroxyethyl(meth)acrylate, 4-hydroxybutyl(meth)acrylate, 2-hydroxypropyl methacrylate, 2,5-dimethyl-1,6-hexanediol monomethacrylate, hydroxyphenoxypropyl methacrylate, mono(meth)acrylates of oligomeric or polymeric ethers, for example polyethylene glycols, polypropylene glycols or mixed polyethylene/propylene glycols, polyethylene glycol) methyl ether (meth)acrylate, poly(propylene glycol) methyl ether (meth)acrylate of 5 to 80 carbon atoms, methoxyethoxyethyl(meth)acrylate, 1-butoxypropyl(meth)acrylate, cyclohexyloxymethyl(meth)acrylate, methoxymethoxyethyl(meth)acrylate, benzyloxymethyl(meth)acrylate, furfuryl(meth)acrylate, 2-butoxyethyl(meth)acrylate, 2-ethoxyethyl(meth)acrylate, allyloxymethyl(meth)acrylate, 1-ethoxybutyl(meth)acrylate, 1-ethoxyethyl(meth)acrylate, ethoxymethyl(meth)acrylate, caprolactone- and/or valerolactone-modified hydroxyalkyl(meth)acrylates having a number-average molecular weight Mₙ in the range from 220 to 1200,

wherein the hydroxy(meth)acrylates are preferably derived from straight-chain, branched or cycloaliphatic diols of 2 to 8 carbon atoms; (meth)acrylates of halogenated alcohols, preferably perfluoroalkyl(meth)acrylates of 6 to 20 carbon atoms; oxirane-containing (meth)acrylates, preferably 2,3-epoxybutyl methacrylate, 3,4-epoxybutyl methacrylate and glycidyl(meth)acrylate; styrene and substituted styrenes, preferably α-methylstyrene or 4-methylstyrene; methacrylonitrile and acrylonitrile; vinyl-containing, non-basic cycloaliphatic heterocycles having at least one nitrogen atom as ring member, preferably 1-[2-(methacryloyloxy)ethyl]-2-imidazolidine and N-vinyl-pyrrolidone, N-vinylcaprolactam; vinyl esters of monocarboxylic acids having 1 to 20 carbon atoms, preferably vinyl acetate; maleic anhydride and diesters thereof; maleimide, N-phenylmaleimide and N-substituted maleimides with straight-chain, branched or cycloaliphatic alkyl groups of 1 to 22 carbon atoms, preferably N-ethylmaleimide and N-octylmaleimide; (meth)acrylamide; N-alkyl- and N,N-dialkyl-substituted acrylamides with straight-chain, branched or cycloaliphatic alkyl groups of 1 to 22 carbon atoms, preferably N-(t-butyl)acrylamide and N,N-dimethylacryl-amide, wherein none of the monomers contains an acidic functional group.

After polymerization has taken place, the structural units I-III which derive from these ethylenically unsaturated monomers may be still further modified.

For instance, oxirane structures may be reacted with nucleophilic compounds, such as 4-nitrobenzoic acid. Hydroxyl groups may be reacted with lactones, for example ε-caprolactone, to form polyesters, and ester groups may be subjected to acid- or base-catalyzed ester cleavage to release polymer structural units comprising OH groups.

Copolymers (4) obtained by polymerization of ethylenically unsaturated monomers and having deprotonatable groups in structural units IV-VII are at least partially saltable using a known method.

For salting, the structural units IV-VII with deprotonatable groups can be reacted with at least one, optionally oligomeric, preferably organic compound (5) as recited hereinafter, which has at least one basic group.

The basic compound (5) used as suitable for salting the structural units IV-VII can be at least one salt-forming compound selected from the group comprising metal oxides and hydroxides, metal (hydrogen)carbonates, ammonia, optionally substituted aliphatic and aromatic amines. Preference for use as basic compound (5) for salting the structural units IV-VII is given to using organic compounds based on optionally substituted, aliphatic and/or aromatic amines.

Useful amines include aliphatic or aromatic primary, secondary and tertiary amines. Preferred amines are aliphatic amines of 1-24 carbon atoms, which may optionally be substituted with hydroxyl groups and/or alkoxy groups, cycloaliphatic amines of 4-20 carbon atoms, which may be optionally substituted with hydroxyl groups and/or alkoxy groups, aromatic amines of 6-24 carbon atoms, which may be optionally substituted with hydroxyl groups and/or alkoxy groups.

Examples of such preferred amines are monomethylamine, monoethylamine, n-propylamine, isopropylamine, butylamine, n-pentylamine, t-butylamine, hexylamine, octylamine, 2-ethylhexylamine, dodecylamine, tridecylamine, oleylamine, dimethylamine, diethylamine, dipropylamine, dibutylamine, dihexylamine, bis(2-ethyl-hexyl)amine, bis(tridecyl)amine, 3-methoxypropylamine, 2-ethoxyethylamine, 3-ethoxypropylamine, 3-(2-ethylhexyloxy)propylamine, cyclopentylamine, cyclohexylamine, 1-phenylethylamine, dicyclohexylamine, benzylamine, N-methylbenzylamine, N-ethylbenzylamine, 2-phenylethylamine, aniline, o-toluidine, 2,6-xylidine, 1,2-phenylenediamine, 1,3-phenylenediamine, 1,4-phenylenediamine, o-xylylenediamine, m-xylylenediamine, p-xylylenediamine, ethylenediamine, 1,3-propanediamine, 1,2-propanediamine, 1,4-butanediamine, 1,2-butane-diamine, 1,3-butanediamine, neopentanediamine, hexa-methylenediamine, octamethylenediamine, isophorone-diamine, 4,4′-diaminodicyclohexylmethane, 3,3′-dimethyl-4,4′-diaminodicyclohexylmethane, 4,4′-diaminodiphenylmethane, 4,9-dioxyadodecane-1,12-diamine, 4,7,10-trioxamidecane-1,13-diamine, 3-(methylamino)propylamine, 3-(cyclohexylamino)propylamine, 3-(diethyl-amino)ethylamine, 3-(dimethylamino)propylamine, 3-(diethylamino)propylamine, diethylenetriamine, tri-ethylenetetramine, tetraethylenepentamine, 3-(2-amino-ethyl)aminopropylamine, dipropylenetriamine, N,N-bis(3-aminopropyl)methylamine, N,N′-bis(3-aminopropyl)-ethylenediamine, bis(3-dimethylaminopropyl)amine, N-(3-aminopropyl)imidazole, monoethanolamine, 3-amino-1-propanol, isopropanolamine, 5-amino-1-pentanol, 2-(2-aminoethoxy)ethanol, aminoethylethanolamine, N-(2-hydroxyethyl)-1,3-propanediamine, N-methylethanolamine, N-ethylethanolamine, N-butylethanolamine, diethanol-amine, 3-((2-hydroxyethyl)amino)-1-propanol, diisopropanolamine, N-(2-hydroxyethyl)aniline, 1-methyl-3-phenylpropylamine, furfurylamine, N-isopropylbenzyl-amine, 1-(1-naphthyl)ethylamine, N-benzylethanolamine, 2-(4-methoxyphenyl)ethylamine, N,N-dimethylaminoethyl-amine, ethoxypropylamine, 2-methoxyethylamine, 2-ethoxyethylamine, 2-cyclohexenylethylamine, piperidine, diethylaminopropylamine, 4-methylcyclohexylamine, hydroxynovaldiamine, 3-(2-ethylhexyloxy)propylamine, tris(2-aminoethyl)amine, N,N′-ditert-butylethylene-diamine, tris(hydroxymethyl)aminomethane, triethylamine, triethanolamine, dimethylethanolamine, dibutylethanolamine, dimethylaminopropanol, 2-amino-2-methylpropanol, dimethylaminopyridine, morpholine, methylmorpholine, aminopropylmorpholine.

Polyethers having at least one amino end group can also be used. The polyether is preferably based on an alkylene oxide, preferably ethylene oxide and/or propylene oxide and/or optionally further epoxides such as, for example, butylene oxide, styrene oxide, or tetrahydrofuran, and is functionalized with amino groups. The polyethers may have one, two or more than two amino groups, depending on their construction. Products of this type are marketed for example by Huntsman under the name “Jeffamine” or by BASF as “Polyetheramine” and bear for example the designations M-600, M-1000, M-2005, M-2070, D-230, D-400, D-2000, D-4000, T-403, T-3000, T-5000, Polytetrafuranamin 1700, ED-600, ED-900, ED-2003, HK-511, EDR-148, EDR-176, SD-231, SD-401, SD-2001, ST-404.

Further possible salting components are dendritic polyimine structures such as preferably polyethylene-imines and/or polypropyleneimines, more preferably polyethyleneimines. These polyimines may optionally also be modified through alkoxylation of amino functions. A further possible way to modify the polyimines is to react them with fatty acids.

In a particularly preferred embodiment of the present invention, alkoxylated mono- and/or polyamines are used as aminic salting component. Examples thereof are alkoxylated alkylamines, alkenylamines, alkylenediamines, alkenylenediamines and polyamines, for example alkoxylated derivatives of ethylenediamine, of diethylenetriamine, of triethylenetetramine, and also of higher homologs thereof and also alkoxylated derivatives of stearylamine, of oleylamine or of cocoamine. Oligomeric ethoxylates of primary amines bearing a branched or unbranched alkyl or alkenyl moiety of 6-24 carbon atoms on the nitrogen are very particularly preferred salting components.

By using already salted, i.e., by deprotonating the acidic functional groups of ethylenically unsaturated monomers, the structural units IV-VII are obtainable in their ready-salted form by direct polymerization of salted monomers.

Examples of such monomers which can be used directly for polymerization are for instance sodium (meth)acrylate, potassium (meth)acrylate, sodium styrenesulfonate, potassium 3-sulfopropyl(meth)acrylate, sodium 3-allyloxy-2-hydroxypropanesulfonate or the potassium salt of bis(3-sulfopropyl)itaconate.

The copolymer (4) used according to the present invention, in addition to the structural units I-VII, may optionally further comprise structural units derived from free-radically or ionically copolymerizable α,β-unsaturated monomers subject to the proviso that their copolymerization does not cause the molar ratio of acidic functional groups to optionally present N-containing, basic groups to drop below at least 5:1 in the copolymer.

The proportion of these free-radically or ionically copolymerizable α,β-unsaturated monomers in copolymer (4) is preferably not more than 10 wt %.

The proportion of these free-radically or ionically copolymerizable α,β-unsaturated monomers in copolymer (4) is more preferably not more than 5 wt %.

It is very particularly preferable for copolymer (4) to consist exclusively of structural units I to VII and not to contain any further structural units derived from such free-radically or ionically copolymerizable α,β-unsaturated monomers.

In a very particularly preferred embodiment of the present invention, compatibilizer additive (4) is a salting product formed from a structured copolymer where the structural units present as structural units I to III were obtained by polymerization of styrene or benzyl(meth)acrylate and the structural units present as structural units IV to VII were obtained by polymerization of (meth)acrylic acid, carboxyethyl(meth)acrylate or maleic acid and/or its derivatives, and from an alkoxylated alkyl- or alkenylmonoamine, wherein at least 50% of the acid groups are in salted form. The invention accordingly also provides these very particularly preferred salting products themselves.

Preferably, the compatibilizer additive (4) is a structured copolymer and more preferably a block, gradient or comb copolymer, preferably produced by a controlled free-radical or ionic process of polymerization.

It is particularly preferable to produce such compatibilizer additives (4) through controlled free-radical polymerization or group transfer polymerization.

Depending on which of the polymerization techniques recited hereinafter is used, different copolymers are obtained even when identical ethylenically unsaturated monomers are used and even at the same molar ratios, since the different polymerization techniques can lead to different microstructures or to be more precise to different sequences of structural units I-VII. For instance, block copolymers produced by different techniques from identical monomer mixtures will be obtained with differently microstructured blocks. In addition, the copolymers can also differ distinctly in respect of their molecular weight and their molecular weight distribution. The same holds for gradientlike copolymers.

Various processes are known in the literature for conducting a controlled polymerization. An overview of some processes is found in Prog. Polym. Sci. 32 (2007) 93-146 and in Chem. Rev. 2009, 109, 4963-5050.

As polymerization techniques to produce the copolymers used as compatibilizer additive (4) in the compositions of the invention there can be used any prior art polymerization technique for polymerizing ethylenically unsaturated monomers.

Some technologies for conducting controlled polymerizations will now be mentioned by way of example:

Atom transfer radical polymerization (ATRP) provides a controlled polymerization and is described for example in Chem. Rev. 2001, 101, 2921 and in Chem. Rev. 2007, 107, 2270-2299.

The controlled methods of polymerization also include the reversible addition fragmentation chain transfer process (RAFT) which, when certain polymerization regulators are used, is also known as MADIX (macromolecular design via the interchange of xanthates) and addition fragmentation chain transfer. RAFT is described for example in Polym. Int. 2000, 49, 993, Aust. J. Chem. 2005, 58, 379, J. Polym. Sci. Part A: Polym. Chem. 2005, 43, 5347, Chem. Lett. 1993, 22, 1089, J. Polym. Sci., Part A 1989, 27, 1741 and also 1991, 29, 1053 and also 1993, 31, 1551 and also 1994, 32, 2745 and also 1996, 34, 95 and also 2003, 41, 645 and also 2004, 42, 597 and also 2004, 42, 6021 and in Macromol. Rapid Commun. 2003, 24, 197, in Polymer 2005, 46, 8458-8468 and also in Polymer 2008, 49, 1079-1131 and in U.S. Pat. No. 6,291,620, WO 98/01478, WO 98/58974 and WO 99/31144.

A further process for controlled polymerization utilizes nitroxyl compounds as polymerization regulators (NMP) and is disclosed for example in Chem. Rev. 2001, 101, 3661.

A further controlled method of polymerization is group transfer polymerization (GTP) as disclosed for example in O. W. Webster in “Group Transfer Polymerization”, in “Encyclopedia of Polymer Science and Engineering”, volume 7, H. F. Mark, N. M. Bikales, C. G. Overberger and G. Menges, Eds., Wiley Interscience, New York 1987, page 580 ff., and also in O. W. Webster, Adv. Polym. Sci. 2004, 167, 1-34.

The controlled free-radical polymerization with tetraphenylethane as described in Macromol. Symp. 1996, 111, 63 for example is a further example of a controlled polymerization for producing the copolymers used according to the present invention.

A controlled free-radical polymerization with 1,1-diphenylethene as polymerization regulator is described for example in Macromolecular Rapid Communications, 2001, 22, 700.

The controlled free-radical polymerization with organotellurium, organoantimony and organobismuth chain transfer agents is described in Chem. Rev. 2009, 109, 5051-5068.

A controlled free-radical polymerization with iniferters is disclosed for example in Makromol. Chem. Rapid. Commun. 1982, 3, 127.

A controlled free-radical polymerization with organocobalt complexes is known for example from J. Am. Chem. Soc. 1994, 116, 7973, from Journal of Polymer Science: Part A: Polymer Chemistry, Vol. 38, 1753-1766 (2000), from Chem. Rev. 2001, 101, 3611-3659 and also from Macromolecules 2006, 39, 8219-8222.

A further controlled free-radical polymerization process is reversible chain transfer catalyzed polymerization as disclosed in Polymer 2008, 49, 5177.

A further controlled technique of polymerization is degenerative chain transfer with iodine compounds as described for example in Macromolecules 2008, 41, 6261, in Chem. Rev. 2006, 106, 3936-3962 or in U.S. Pat. No. 7,034,085.

The controlled free-radical polymerization in the presence of thioketones is described for example in Chem. Commun. 2006, 835-837 and in Macromol. Rapid Commun. 2007, 28, 746-753.

Preferably, the preferably structured copolymers used according to the present invention are obtainable using any prior art living controlled techniques of polymerization such as for example ATRP, RAFT, MADIX, NMP, GTP, the controlled free-radical polymerization with tetraphenylethane, the controlled free-radical polymerization with 1,1-diphenylethene, the controlled free-radical polymerization with iniferters, the reversible chain transfer catalyzed polymerization, the controlled free-radical polymerization in the presence of thioketones and the controlled free-radical polymerization with organocobalt complexes.

The initiators used in the particular polymerization processes are known to a person having ordinary skill in the art. Free-radical polymerization processes for example can utilize not only azo initiators such as azodiisobutyronitrile, peroxy compounds, such as dibenzoyl peroxide and dicumyl peroxide, but also persulfates such as ammonium peroxodisulfate, sodium peroxodisulfate and potassium peroxodisulfate.

Similarly, the initiators, polymerization regulators and catalysts used for the living controlled polymerization processes are known to a person having ordinary skill in the art.

Initiators for atom transfer radical polymerization are for example haloalkanes having 1 to 10 carbon atoms, such as carbon tetrabromide and 1,1,1-trichloroethane; haloalcohols having 2 to 10 carbon atoms, such as 2,2,2-trichloroethanol; 2-halo carboxylic acid and esters thereof having 2 to 20 carbon atoms, such as chloroacetic acid, 2-bromopropionic acid, methyl 2-bromopropionate, methyl 2-chloropropionate, ethyl 2-bromoisobutyrate and ethyl 2-chloroisobutyrate; 2-halo carbonitriles having 2 to 10 carbon atoms, such as 2-chloroacetonitrile and 2-bromopropionitrile; alkyl and aryl sulfonyl chlorides having 2 to 10 carbon atoms, such as methanesulfonyl chloride and benzenesulfonyl chloride; and 1-aryl-1-haloalkanes having 7 to 20 carbon atoms, for example benzyl chloride, benzyl bromide and 1-bromo-1-phenylethane. Catalysts for ATRP are for example copper chloride or bromide complexes with nitrogenous ligands such as 2,2′-bipyridine or N,N,N′,N″,N″-pentamethyldiethylenetriamine, which can also be generated in situ from copper metal, ligand and initiator. Further catalysts are recited in Chem. Rev. 2001, 101, 2921 and in Prog. Polym. Sci. 32 (2007) 93-146 and also in Chem. Rev. 2007, 107, 2270-2299.

It is also prior art for some polymerization processes to utilize adducts of the initiator with the polymerization regulator, for example alkoxyamines for the NMP process. Examples thereof are recited in Chem. Rev. 2001, 101, 3661, “V. Approaches to Alkoxyamines” or in Angewandte Chemie Int. Ed. 2004, 43, 6186.

It is further possible to form initiators/regulators in situ as described for example in Macromol. Rapid Commun. 2007, 28, 147 for the NMP process.

Further examples of initiators/regulators for the NMP process are for example 2,2,6,6-tetramethylpiperidine oxyl (TEMPO) or N-tert-butyl-N-[1-diethylphosphono(2,2-dimethylpropyl)]nitroxyl and also the compounds recited in ACS Symposium Series 2009, 1024 (Controlled/Living Radical Polymerization: Progress in RAFT, DT, NMP & OMRP), 245-262 and in WO 96/24620 and DE 60 2004 008967.

The GTP process may utilize silylketene acetals such as, for example, [(1-methoxy-2-methyl-1-propenyl)oxy]-trimethylsilane as initiators. Further examples are found in U.S. Pat. No. 4,822,859, U.S. Pat. No. 4,780,554 and EP 0184692 B1.

GTP employs fluorides described in U.S. Pat. No. 4,659,782 on oxyanions described in U.S. Pat. No. 4,588,795 as catalysts. A preferred catalyst for GTP is tetrabutylammonium m-chlorobenzoate.

Chain transfer agents for the RAFT process include for example thiocarboxylic esters, thiocarbamates or xanthic esters, which are often used in combination with free-radical initiators such as, for example, azo initiators, peroxy compounds or persulfates.

Catalysts for controlled free-radical polymerization with organocobalt complexes are recited for example in Chem. Rev. 2001, 101, 3611.

Further examples of initiators, chain transfer agents and catalysts used for the living controlled polymerization processes are mentioned in the above-cited literature concerning the polymerization techniques. The use of so-called dual- or heterofunctional initiators, described in Prog. Polym. Sci. 31 (2006) 671-722 for example, is also possible.

The recited polymerizations can be carried out in organic solvents and/or water or without a solvent. When solvents are used, the polymerization can be carried out as a classic solvent polymerization, wherein the polymer is dissolved in solvent, or as an emulsion or miniemulsion polymerization, as described for example in Angewandte Chemie Int. Ed. 2004, 43, 6186 and Macromolecules 2004, 37, 4453.

The emulsion or miniemulsion polymer obtained can be water-solubilized by salt formation, so that a homogeneous solution of polymer is produced. However, the copolymers may still be water-insoluble after salting.

The copolymers obtained here are not necessarily defined via the polymerization control agent as end group. The end group can for example be wholly or partly detached after polymerization. For instance, the nitroxyl end group of copolymers produced via NMP can be detached thermally by raising the temperature above the polymerization temperature. This detaching of polymerization control agent can also be accomplished for example by adding further chemical compounds such as polymerization inhibitors, for example phenol derivatives, or by a process as described in Macromolecules 2001, 34, 3856.

A sulfur-containing RAFT agent can be detached from the copolymer thermally by heating the copolymers, by addition of oxidizing agents such as hydrogen peroxide, peracids, ozone or other bleaching agents, or be reacted with nucleophiles such as amines to form a thiol end group.

Furthermore, the halogen end groups generated by ATRP can be detached by elimination reactions or converted into other end groups by substitution reactions. Examples of such transformations are recited in Chem. Rev. 2001, 101, 2921.

The disclosure of these polymerization processes in the particular publication shall also be deemed part of the present disclosure.

The present invention further provides for the production of copolymers (4) used according to the present invention by a living controlled free-radical polymerization or by group transfer polymerization.

The copolymers thus obtained are very useful for ensuring the compatibility of inherently incompatible polyols, or of polyols which become incompatible by addition of at least one additive and/or auxiliary agent (3) in liquid form, as reaction components for the production of polyurethanes.

The incompatibility of polyol component (1) with polyol component (2) can be occasioned inter alia by their different molecular weights, their different constructions and/or their different polarities.

It is accordingly well known that oligomeric or polymeric polyalkylene oxide polyols are incompatible with short-chain polyols. Also prone to separation are polyols of isocyanate-reactive, oligomeric or polymeric polyalkylene oxides when they are constructed from different alkylene oxides or include different proportions of the same type of alkylene oxides, e.g., polyethylene oxides and polypropylene oxides having comparable molecular weights, or polyethers formed from ethylene oxide and propylene oxide which each have approximately the same number of structural units but different proportions of ethylene oxide and propylene oxide.

The same holds for polyester or polyether-polyester polyols.

The problem presents in similar fashion also with other types of polymeric polyols, for example polyacrylate polyols, i.e., acrylate copolymers having hydroxyl groups, or hydroxyl-functional polybutadiene.

Any tendency for polyols to separate can also be increased by adding at least one further polyol and/or—as already mentioned—by adding an additive or auxiliary agent.

The employed compatibilizer additive (4) of the present invention remedies such variously caused separation tendencies and ensures storage-stable, monophasic compositions for polyol components (1) and (2) with optionally added additives and/or auxiliary agents at 20° C. from the time of their being mixed up to their further reactive conversion with the polyisocyanate component, preferably for at least 50% longer, but at least for 6 hours longer compared with a corresponding composition without added compatibilizer additive (4).

It is particularly preferable for the storage-stable, monophasic composition to be storage-stable at 20° C. for at least 100% longer, but at least for 12 hours longer compared to a corresponding composition without added compatibilizer additive (4).

It is very particularly preferable for the storage-stable, monophasic composition to be storage-stable at 20° C. for at least 200% longer, but at least for 24 hours longer compared to a corresponding composition without added compatibilizer additive (4).

The polyol component (1) contains at least one polyol of general formula

HO—B*—OH,

where B* represents a divalent radical selected from the group comprising
(i) alkylene radicals having 2 to 8 carbon atoms;
(ii) radicals of formula —CH₂—B′—CH₂—, in each of which B′ represents one of the groups 1a)-5a)

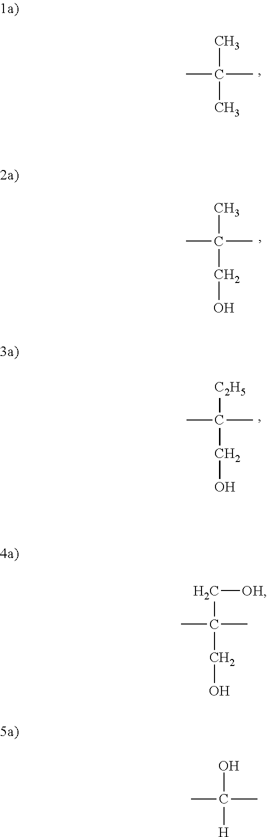

(iii) radicals of structural formula —(B″—O)ₙ—B″—, where B″ is an alkylene radical having 2 to 4 carbon atoms and n is an integer from 1 to 20 and preferably from 1 to 10, and
(iv) a moiety derived from a polyether, polyester or polyether-polyester and optionally branched and containing further OH groups.

The polyol component (1) is preferably at least one short-chain polyol, preferably an aliphatic polyol having 2-8 carbon atoms and at least two hydroxyl groups, at least one polyalkylene oxide with at least two terminal hydroxyl groups or at least one polyester polyol and/or polyether-polyester polyol.

The second isocyanate-reactive polyol component (2) is preferably a polyalkylene oxide having at least two terminal hydroxyl groups and more preferably a polyalkylene oxide deriving from alkylene oxides having to 4 carbon atoms, preferably from ethylene oxide and/or propylene oxide. These polyalkylene oxides have 2, 3 or more terminal hydroxyl groups and 5 to 100 alkylene oxide units, depending on whether they were initiated using a low molecular weight diol, glycerol or more hydric alcohol. In special cases, the polyalkylene oxides may also be initiated using amines, for example aliphatic diamines.

When the comparatively high molecular weight polyol component is constructed not just from a particular alkylene oxide, the polyalkylene oxide in question can have a random or blocklike construction, and in the case of a blocklike construction randomly constructed blocks and blocks constructed of just one particular alkylene oxide at a time can alternate.

Preference for use as polyol component (2) is further given to polyester polyols and/or polyether/polyester polyols and also polybutadiene polyols, while it is preferable for the construction of polyol component (1) to differ from the construction of polyol component (2).

It is preferable for the composition of the present invention to be a mixture between mutually incompatible polyether polyols with polyester polyols or between mutually incompatible different polyether polyols or between mutually incompatible different polyester polyols.

A preferred composition of the present invention includes a polyether polyol as polyol component (1) and a polyester polyol as polyol component (2).

A particularly preferred composition of the present invention includes as polyol component (1) a polyether polyol in which the weight fraction of ethylene oxide units based on the mass of ethylene oxide and propylene oxide units is higher than 65 wt % and as polyol component (2) a polyether polyol in which the weight fraction of propylene oxide units based on the mass of ethylene oxide and propylene oxide units is higher than 65 wt %.

A very particularly preferred composition of the present invention includes as polyol component (1) a polyether polyol in which the weight fraction of ethylene oxide units based on the mass of ethylene oxide and propylene oxide units is higher than 75 wt % and as polyol component (2) a polyether polyol in which the weight fraction of propylene oxide units based on the mass of ethylene oxide and propylene oxide units is higher than 75 wt %.

With the addition of compatibilizer additive (4), preferably in liquid form, i.e., as a liquid per se or in dissolved form, it is possible to extend the period without phase separation of a polyol mixture until the conversion of the polyols into polyurethanes by simple admixing.

The copolymer (4) added to the polyol mixture is not present therein in the form of solid particles, but preferably in liquid form.

To produce the compositions of the present invention, the polyol component (1) and the polyol component (2), which is inherently incompatible therewith or becomes incompatible through the addition of at least one auxiliary agent and/or additive in liquid form, are homogenized in the presence of compatibilizer additive (4), preferably by shaking or stirring.

Any usual auxiliary agents and/or additives used in the production of polyurethanes can already be mixed in at this stage, if required. Alternatively, these agents can also be added at a later date, directly before or during the conversion into polyurethanes.

Examples of such additives and auxiliary agents are catalysts and accelerants (for example in the form of basic compounds such as tertiary amines or in the form of organometallic compounds such as organotins), foaming agents (physical foaming agents such as, for example, hydrocarbons or halogenated hydrocarbons and also chemical foaming agents such as, for example, water or carboxylic acids), foam stabilizers, antifoams, deaerators, viscosity reducers, thixotropic agents, chain extenders and crosslinkers, heat stabilizers, flame retardants, wetting and dispersing agents, stabilizers, such as UV stabilizers or other photoprotectants, hydrolysis stabilizers, oxidation inhibitors, dyes, pigments, organic or inorganic fillers, process additives, adhesion promoters, release agents, plasticizers, antistats, water, solvents. If they are in liquid form, they can already be added to the composition of the present invention.

In a preferred embodiment of compositions according to the present invention based on 100 wt % of the composition, the proportions are

polyol component (1) in the range from 10 to 90 wt %,
polyol component (2) in the range from 10 to 90 wt %,
compatibilizer additive (4) in the range from 0.25 to 7.5 wt %,
additives and/or auxiliary agents (3) in the range from 0.1-25 wt %,
wherein the total amount of the composition must always add up to 100 wt % and the proportion of components (1) to (4) in the composition is at least 80 wt % and preferably at least 95 wt %.

Particular preference is given to a composition according to the present invention where, based on 100 wt % of the composition, the proportion of compatibilizer additive (4) is in the range from 0.5 to 4 wt %.

In a very particularly preferred embodiment of compositions according to the present invention based on 100 wt % of the composition, the proportions are

polyol component (1) in the range from 20 to 80 wt %,
polyol component (2) in the range from 20 to 80 wt %,
compatibilizer additive (4) in the range from 0.5 to 4 wt %,
additives and/or auxiliary agents (3) in the range from 0.1-15 wt %,

wherein the total amount of the composition must always add up to 100 wt % and the proportion of components (1)-(4) in the composition is at least 95 wt %.

Particular preference is given to compositions according to the present invention in which component (3) amounts to less than 5 wt %, based on 100 wt % of the composition, and preferably consists only of at least one solvent.

Very particular preference is given to compositions according to the present invention in which component (3) is initially nearly not present, i.e., the proportion in the composition is below 0.1 wt %, based on 100 wt % of the composition, or is not present at all.

Preferably, in the compositions of the present invention formed from (1) to (4), the molar ratio of acidic groups, optionally wholly or partly in their salted form, to the hydroxyl groups coming from polyol components (1) and (2) is below 0.25.

The compositions of the present invention can be used as stable polyol component for production of polyurethanes by reaction thereof with organic polyisocyanate compounds in the presence of suitable catalysts.

A person skilled in the art knows that depending on the choice of reaction conditions for the reaction of polyols with polyisocyanates, not only polyurethanes but also polyisocyanurates and/or polyureas can be formed. For the purposes of the present invention, therefore, polyisocyanurates and polyureas are also subsumed under the term “polyurethanes”.

Examples of suitable organic polyisocyanates are organic compounds having two or more isocyanate groups. These compounds are known for production of polyurethanes. Suitable organic polyisocyanates comprise hydrocarbon diisocyanates, such as alkylene and arylene diisocyanates, and also known triisocyanates.

Suitable polyisocyanates are, for example, 1,2-diisocyanatoethane, 1,3-diisocyanatopropane, 1,2-diisocyanatopropane, 1,4-diisocyanatobutane, 1,5-diisocyanatopentane, 1,6-diisocyanatohexane, bis(3-isocyanatopropyl)ether, bis(3-isocyanatopropyl) sulfide, 1,7-diisocyanatoheptane, 1,5-diisocyanato-2,2-dimethylpentane, 1,6-diisocyanato-3-methoxyhexane, 1,8-diisocyanatooctane, 1,5-diisocyanato-2,2,4-trimethylpentane, 1,9-diisocyanatononane, 1,10-diisocyanatopropyl ether of 1,4-butylene glycol, 1,11-diisocyanatoundecane, 1,12-diisocyanatododecane, bis(isocyanatohexyl)sulfide, 1,4-diisocyanatobenzene, 2,4-diisocyanatotoluene, 2,6-diisocyanatotoluene, 2,4-diisocyanato-1-chlorobenzene, 2,4-diisocyanato-1-nitrobenzene and 2,5-diisocyanato-1-nitrobenzene and also mixtures thereof. Further suitable compounds comprise 4,4-diphenylmethane diisocyanate, 1,5-naphthylene diisocyanate, isophorone diisocyanate and 1,4-xylylene diisocyanate. Suitable compounds also include the modified liquid MDI isocyanates of U.S. Pat. No. 3,384,653 and various quasi prepolymers of U.S. Pat. Nos. 3,394,164, 3,644,457, 3,457,200 and 3,883,571.

Particularly preferred polyisocyanates are tolylene diisocyanate, diphenylmethyl diisocyanate (in the form of “monomer MDI” or “polymer MDI”), isophorone diisocyanate, hexamethylene diisocyanate and also oligomers thereof.

Polyisocyanates can also be used as masked polyisocyanates which only react at temperatures above 100° C. and are optionally already present in the compositions of the present invention.

Suitable catalysts and/or foaming agents are discernible from German laid-open document DOS 2730374 for example.

The production of polyurethanes by reacting the compositions of the present invention as phase separation stabilized polyol components, optionally containing additives and/or auxiliary agents, with polyisocyanates can be used to produce polyurethane foams as well as to produce unfoamed polyurethane materials (CASE applications); the production of polyurethanes is known in the art and is described for example in R. Leppkes, “Die Bibliothek der Technik, Bd. 91: Polyurethane”, Verlag moderne Industrie, Landsberg/Lech 1993, and also in R. Herrington, K. Hock, “Flexible Polyurethane Foams”, Dow Chemical Comp., Midland (USA) 1997, and also in S. Lee, “The Huntsman Polyurethanes Book”; Huntsman Int. LLC, 2002, and also in U. Meier-Westhues, “Polyurethane—Lacke, Kleb- and Dichtstoffe”, Vincentz Network, 2007, and also in G. Oertel, “Kunststoffhandbuch, Bd. 7: Polyurethane”, Hanser Fachbuch, 2004, and also in K. Uhlig, “Polyurethan-Taschenbuch”, Hanser Fachbuchverlag, 2005.

The present invention accordingly also provides for the use of compositions of the present invention as a phase separation stabilized polyol component, optionally containing additives and/or auxiliary agents, for production of polyurethanes and also a process for production of polyurethanes where in each case the compositions of the present invention, which comprise phase separation stabilized polyol mixtures, are made to react with organic polyisocyanates in the presence of catalysts.

The present invention also provides polyurethane masses, polyurethane bodies and/or polyurethane foams produced using a composition of the present invention, comprising a phase separation stabilized polyol mixture, optionally containing additives and/or auxiliary agents, by reaction with organic polyisocyanates in the presence of catalysts. These polyurethane masses, polyurethane bodies and/or polyurethane foams can be used in all sectors where such articles are used, for example in the sector of engineering components up to coatings, potting compounds, adhesives, elastomers, sealants, insulants, etc.

### EXAMPLES

### I) Production of Additives

Molecular weights were determined using gel permeation chromatography (GPC).

Calibration is done with polystyrene standards having a molecular weight of M_{P} 1 000 000 to 162.

Tetrahydrofuran for analysis with 1% acetic acid is used as mobile phase.

The following parameters are maintained in the duplicate measurement:

Degassing: online degasser
Flow rate: 1 ml/min
Analysis time: 45 minutes
Detectors: refractometer and UV detector
Injection volume: 100 μl-200 μl

Molar mass averages M_{w}; Mₙ and Mₚ and also the polydispersity M_{w}/Mₙ are software computed. Base line points and evaluation limits are defined in accordance with DIN 55672 Part 1.

Residual monomer content was determined using high performance liquid chromatography (HPLC).

Structure, preparation and use of O-ethyl-S-(1-methoxy-carbonylethyl)xanthate are described in Macromol. Rapid Commun. 2001, 22, 1497.

Copolymer 1:

In a three-neck flask equipped with stirrer, reflux condenser and gas inlet, 142.7 g of 1-methoxy-2-propyl acetate and 38.1 g of 2-[N-tert-butyl-N-[1-diethyl-phosphono(2,2-dimethylpropyl)]nitroxy]-2-methyl-propanoic acid and also 104.0 g of styrene are initially charged and heated to 120° C. under nitrogen.

Stirring is continued at 120° C. for 2.5 h (styrene conversion thereafter: 62.2% as per HPLC).

Thereafter, 72.0 g of acrylic acid are added over 10 min through a dropping funnel at 120° C. Stirring is continued at 120° C. for 6 h (overall conversion: 98.5% as per HPLC). Product: Mₙ=2530 g/mol (as per GPC).

Copolymer 2:

In a three-neck flask equipped with stirrer, reflux condenser and gas inlet, 119.3 g of 1-methoxy-2-propyl acetate and 38.1 g of 2-[N-tert-butyl-N-[1-diethyl-phosphono(2,2-dimethylpropyl)]nitroxy]-2-methyl-propanoic acid and also 83.2 g of styrene are initially charged and heated to 120° C. under nitrogen. Stirring is continued at 120° C. for 2.5 h (styrene conversion thereafter: 69.0% as per HPLC). Thereafter, 57.6 g of acrylic acid are added over 10 min through a dropping funnel at 120° C. Stirring is continued at 120° C. for 6 h (overall conversion: 97.2% as per HPLC). Product: Mₙ=2720 g/mol (as per GPC).

Copolymer 3:

In a three-neck flask equipped with stirrer, reflux condenser and gas inlet, 131.6 g of 1-methoxy-2-propyl acetate and 20.8 g of O-ethyl-S-(1-methoxycarbonyl-ethyl)xanthate are initially charged and heated to 85° C. under nitrogen. At 85° C., 104.0 g of styrene and 0.3 g of 2,2′-azobis[2-methylbutyronitrile] dissolved therein are added over 90 min. Stirring is continued at 85° C. for 4 h (styrene conversion thereafter: 52.0% as per HPLC). Thereafter, at 85° C., 72.0 g of acrylic acid and 0.3 g of 2,2′-azobis[2-methylbutyronitrile] dissolved therein are added over 30 min. Stirring is continued at 85° C. for 2 h. Thereafter, 0.3 g of 2,2′-azobis[2-methylbutyronitrile] is added and stirring is continued at 85° C. for 1 further hour. This procedure is repeated 2 more times at intervals of 1 h (overall conversion: 97.8% as per HPLC). Product: Mₙ=2430 g/mol (as per GPC).

Copolymer 4:

In a three-neck flask equipped with stirrer, reflux condenser and gas inlet, 108.1 g of 1-methoxy-2-propyl acetate and 20.8 g of O-ethyl-S-(1-methoxycarbonyl-ethyl)xanthate are initially charged and heated to 85° C. under nitrogen. At 85° C., 83.2 g of styrene and 0.3 g of 2,2′-azobis[2-methylbutyronitrile] dissolved therein are added over 90 min. Stirring is continued at 85° C. for 4 h (styrene conversion thereafter: 49.0% as per HPLC).

Thereafter, at 85° C., 57.6 g of acrylic acid and 0.3 g of 2,2′-azobis[2-methylbutyronitrile] dissolved therein are added over 30 min. Stirring is continued at 85° C. for 2 h. Thereafter, 0.3 g of 2,2′-azobis[2-methylbutyronitrile] is added and stirring is continued at 85° C. for 1 further hour. This procedure is repeated 2 more times at intervals of 1 h (overall conversion: 97.9% as per HPLC). Product: Mₙ=2000 g/mol (as per GPC).

Copolymer 5:

In a three-neck flask equipped with stirrer, reflux condenser and gas inlet, 166.3 g of 1-methoxy-2-propyl acetate and 20.8 g of O-ethyl-S-(1-methoxycarbonyl-ethyl)xanthate are initially charged and heated to 85° C. under nitrogen. At 85° C., 156.0 g of styrene and 0.3 g of 2,2′-azobis[2-methylbutyronitrile] dissolved therein are added over 90 min. Stirring is continued at 85° C. for 4 h (styrene conversion thereafter: 45.0% as per HPLC). Thereafter, at 85° C., 72.0 g of acrylic acid and 0.3 g of 2,2′-azobis[2-methylbutyronitrile] dissolved therein are added over 30 min. Stirring is continued at 85° C. for 2 h. Thereafter, 0.3 g of 2,2′-azobis[2-methylbutyronitrile] is added and stirring is continued at 85° C. for 1 further hour. This procedure is repeated 2 more times at intervals of 1 h (overall conversion: 96.7% as per HPLC). Product: Mₙ=3060 g/mol (as per GPC).

Copolymer 6:

In a three-neck flask equipped with stirrer, reflux condenser and gas inlet, 100.8 g of 1-methoxy-2-propyl acetate and 10.4 g of O-ethyl-S-(1-methoxycarbonyl-ethyl)xanthate are initially charged and heated to 85° C. under nitrogen. At 85° C., 104.0 g of styrene and 0.15 g of 2,2′-azobis[2-methylbutyronitrile] dissolved therein are added at a rate of 1.7 mL/min. Stirring is continued at 85° C. for 30 min (styrene conversion thereafter: 34.4% as per HPLC). Thereafter, at 85° C., 36.0 g of acrylic acid and 0.15 g of 2,2′-azobis[2-methylbutyronitrile] dissolved therein are added at a rate of 2.4 mL/min. Stirring is continued at 85° C. for 30 min. Thereafter, 0.15 g of 2,2′-azobis[2-methylbutyronitrile] is added and stirring is continued at 85° C. for 30 further min. This procedure is repeated more times at intervals of 30 min (overall conversion: 96.8% as per HPLC). Product: Mₙ=2770 g/mol (as per GPC).

Copolymer 7:

In a three-neck flask equipped with stirrer, reflux condenser and gas inlet, 110.4 g of 1-methoxy-2-propyl acetate and 10.4 g of O-ethyl-S-(1-methoxycarbonyl-ethyl)xanthate are initially charged and heated to 85° C. under nitrogen. At 85° C., 104.0 g of styrene and 0.15 g of 2,2′-azobis[2-methylbutyronitrile] dissolved therein are added at a rate of 1.7 mL/min. Stirring is continued at 85° C. for 30 min (styrene conversion thereafter: 37.4% as per HPLC). Thereafter, at 85° C., 50.4 g of acrylic acid and 0.15 g of 2,2′-azobis[2-methylbutyronitrile] dissolved therein are added at a rate of 2.4 mL/min. Stirring is continued at 85° C. for 30 min. Thereafter, 0.15 g of 2,2′-azobis[2-methylbutyronitrile] is added and stirring is continued at 85° C. for 30 further min. This procedure is repeated more times at intervals of 30 min (overall conversion: 96.9% as per HPLC). Product: Mₙ=2620 g/mol (as per GPC).

Copolymer 8:

In a three-neck flask equipped with stirrer, reflux condenser and gas inlet, 166.3 g of 1-methoxy-2-propyl acetate and 20.8 g of O-ethyl-S-(1-methoxycarbonyl-ethyl)xanthate are initially charged and heated to 85° C. under nitrogen. At 85° C., 156.0 g of styrene and 0.3 g of 2,2′-azobis[2-methylbutyronitrile] dissolved therein are added at a rate of 1.7 mL/min. Stirring is continued at 85° C. for 30 min (styrene conversion thereafter: 37.7% as per HPLC). Thereafter, at 85° C., 72.0 g of 2-carboxyethyl acrylate and 0.3 g of 2,2′-azobis[2-methylbutyronitrile] dissolved therein are added at a rate of 2.4 mL/min. Stirring is continued at 85° C. for 30 min. Thereafter, 0.3 g of 2,2′-azobis[2-methylbutyronitrile] is added and stirring is continued at 85° C. for 30 min. This procedure is repeated 4 more times at intervals of 30 min. This is followed by heating to 120° C., a further 0.3 g of 2,2′-azobis[2-methylbutyronitrile] is added and stirring is continued at 120° C. for 3 h. This step is again repeated once more (overall conversion: 92.9% as per HPLC). Product: Mₙ=1930 g/mol (as per GPC).

Copolymer 9:

In a three-neck flask equipped with stirrer, reflux condenser and gas inlet, 166.3 g of 1-methoxy-2-propyl acetate and 20.8 g of O-ethyl-S-(1-methoxycarbonyl-ethyl)xanthate are initially charged and heated to 85° C. under nitrogen.

At 85° C., a mixture of 148.2 g of styrene, 7.8 g of benzyl acrylate and 0.3 g of 2,2′-azobis[2-methyl-butyronitrile] dissolved therein are added over 90 min. Stirring is continued at 85° C. for 4 h (conversion of monomers thereafter: 49.2% as per HPLC). Thereafter, at 85° C., 72.0 g of acrylic acid and 0.3 g of 2,2′-azobis[2-methylbutyronitrile] dissolved therein are added over 30 min. Stirring is continued at 85° C. for 2 h. Thereafter, 0.3 g of 2,2′-azobis[2-methylbutyro-nitrile] is added and stirring is continued at 85° C. for 1 further hour. This procedure is repeated 2 more times at intervals of 1 h (overall conversion: 96.9% as per HPLC). Product: Mₙ=3020 g/mol (as per GPC).

Copolymer 10:

In a three-neck flask equipped with stirrer, reflux condenser and gas inlet, 166.3 g of 1-methoxy-2-propyl acetate and 20.8 g of O-ethyl-S-(1-methoxycarbonyl-ethyl)xanthate are initially charged and heated to 85° C. under nitrogen. At 85° C., a mixture of 148.2 g of styrene, 7.8 g of benzyl methacrylate and 0.3 g of 2,2′-azobis[2-methylbutyronitrile] dissolved therein are added over 90 min. Stirring is continued at 85° C. for 4 h (conversion of monomers thereafter: 43.1% as per HPLC). Thereafter, at 85° C., 72.0 g of acrylic acid and 0.3 g of 2,2′-azobis[2-methylbutyronitrile] dissolved therein are added over 30 min. Stirring is continued at 85° C. for 2 h. Thereafter, 0.3 g of 2,2′-azobis[2-methylbutyronitrile] is added and stirring is continued at 85° C. for 1 further hour. This procedure is repeated 3 more times at intervals of 1 h (overall conversion: 96.4% as per HPLC). Product: Mₙ=3100 g/mol (as per GPC).

Copolymer 11:

In a three-neck flask equipped with stirrer, reflux condenser and gas inlet, 166.3 g of 1-methoxy-2-propyl acetate and 20.8 g of O-ethyl-S-(1-methoxycarbonyl-ethyl)xanthate are initially charged and heated to 85° C. under nitrogen. At 85° C., a mixture of 147.5 g of styrene, 3.0 g of ethyltriglycol methacrylate, 5.5 g of methyl methacrylate and 0.3 g of 2,2′-azobis[2-methyl-butyronitrile] dissolved therein are added over 90 min. Stirring is continued at 85° C. for 4 h (conversion of monomers thereafter: 42.7% as per HPLC). Thereafter, at 85° C., 72.0 g of acrylic acid and 0.3 g of 2,2′-azobis[2-methylbutyronitrile] dissolved therein are added over 30 min. Stirring is continued at 85° C. for 2h.

Thereafter, 0.3 g of 2,2′-azobis[2-methylbutyronitrile] is added and stirring is continued at 85° C. for 1 further hour. This procedure is repeated 3 more times at intervals of 1 h (overall conversion: 97.1% as per HPLC). Product: Mₙ=3220 g/mol (as per GPC).

Copolymer 12:

In a three-neck flask equipped with stirrer, reflux condenser and gas inlet, 166.3 g of 1-methoxy-2-propyl acetate and 20.8 g of O-ethyl-S-(1-methoxycarbonyl-ethyl)xanthate are initially charged and heated to 85° C. under nitrogen. At 85° C., 156.0 g of styrene and 0.3 g of 2,2′-azobis[2-methylbutyronitrile] dissolved therein are added over 90 min. Stirring is continued at 85° C. for 4 h (styrene conversion thereafter: 45.4% as per HPLC). Thereafter, at 85° C., a combination of 68.5 g of acrylic acid, 3.5 g of butyl acrylate and 0.3 g of 2,2′-azobis[2-methylbutyronitrile] dissolved therein are added over 30 min. Stirring is continued at 85° C. for 2 h. Thereafter, 0.3 g of 2,2′-azobis[2-methylbutyronitrile] is added and stirring is continued at 85° C. for 1 further hour. This procedure is repeated 3 more times at intervals of 1 h (overall conversion: 97.1% as per HPLC). Product: Mₙ=3100 g/mol (as per GPC).

Copolymer 13:

In a three-neck flask equipped with stirrer, reflux condenser and gas inlet, 166.3 g of 1-methoxy-2-propyl acetate and 20.8 g of O-ethyl-S-(1-methoxycarbonyl-ethyl)xanthate are initially charged and heated to 110° C. under nitrogen. At 110° C., 156.0 g of styrene and 0.3 g of 2,2′-azobis[2-methylbutyronitrile] dissolved therein are added over 90 min. Stirring is continued at 110° C. for 1.5 h at which point a further 0.15 g of 2,2′-azobis[2-methylbutyronitrile] is added. This procedure is repeated 3 more times (styrene conversion thereafter: 95.4% as per HPLC). Thereafter, at 110° C., 72.0 g of acrylic acid and 0.3 g of 2,2′-azobis[2-methylbutyronitrile] dissolved therein are added over 30 min. Stirring is continued at 85° C. for 2 h. Thereafter, 0.3 g of 2,2′-azobis[2-methylbutyronitrile] is added and stirring is continued at 110° C. for 1 further hour. This procedure is repeated 2 more times at intervals of 1 h (overall conversion: 97.1% as per HPLC). Product: Mₙ=2910 g/mol (as per GPC).

TABLE I
Salting components

| Name | Description |
|---|---|
| Amine 1 | primary polyethermonoamine, average |
| | molecular weight about 2000, ratio of |
| | propylene oxide to ethylene oxide: |
| | 10/31 |
| Amine 2 | stearylamine polyglycol ether, degree |
| | of ethoxylation: about 15 mol of |
| | ethylene oxide per mol of stearylamine |
| Amine 3 | ethylenediamine-based ethylene oxide- |
| | propylene oxide block copolymer, about |
| | 70 mol % of propylene oxide units, |
| | about 30 mol % of ethylene oxide units, |
| | Mₙ about 5900 |
| Amine 4 | oleylamine polyglycol ether, degree of |
| | ethoxylation: about 10 mol of ethylene |
| | oxide per mol of oleylamine |
| Amine 5 | cocoamine polyglycol ether, degree of |
| | ethoxylation: about 5 mol of ethylene |
| | oxide per mol of cocoamine |
| Amine 6 | cocoamine polyglycol ether, degree of |
| | ethoxylation: about 10 mol of ethylene |
| | oxide per mol of cocoamine |
| Amine 7 | polyethyleneimine, molecular weight |
| | about 300 |

Compatibilizer A:

In a three-neck flask equipped with stirrer, reflux condenser and gas inlet, 20.0 g of copolymer 1, 36.5 g of amine 4 and 12.8 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer B:

In a three-neck flask equipped with stirrer, reflux condenser and gas inlet, 20.0 g of copolymer 2, 29.3 g of amine 4 and 9.7 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer C:

In a three-neck flask equipped with stirrer, reflux condenser and gas inlet, 20.0 g of copolymer 3, 39.5 g of amine 4 and 14.1 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer D:

In a three-neck flask equipped with stirrer, reflux condenser and gas inlet, 20.0 g of copolymer 4, 38.4 g of amine 4 and 12.6 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer E:

In a three-neck flask equipped with stirrer, reflux condenser and gas inlet, 20.0 g of copolymer 5, 31.4 g of amine 4 and 10.6 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer F:

In a three-neck flask equipped with stirrer, reflux condenser and gas inlet, 20.0 g of copolymer 5, 27.0 g of amine 4 and 8.7 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer G:

In a three-neck flask equipped with stirrer, reflux condenser and gas inlet, 20.0 g of copolymer 5, 40.5 g of amine 4 and 14.5 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer H:

In a three-neck flask equipped with stirrer, reflux condenser and gas inlet, 20.0 g of copolymer 5, 39.5 g of amine 2 and 14.1 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer I:

In a three-neck flask equipped with stirrer, reflux condenser and gas inlet, 20.0 g of copolymer 5, 29.0 g of amine 6 and 9.6 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer J:

In a three-neck flask equipped with stirrer, reflux condenser and gas inlet, 20.0 g of copolymer 5, 18.6 g of amine 5 and 5.1 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer K:

In a three-neck flask equipped with stirrer, reflux condenser and gas inlet, 20.0 g of copolymer 3, 31.4 g of amine 4 and 10.6 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer L:

In a three-neck flask equipped with stirrer, reflux condenser and gas inlet, 20.0 g of copolymer 6, 25.8 g of amine 4 and 8.2 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer M:

In a three-neck flask equipped with stirrer, reflux condenser and gas inlet, 20.0 g of copolymer 7, 33.2 g of amine 4 and 11.4 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer N:

In a three-neck flask equipped with stirrer, reflux condenser and gas inlet, 20.0 g of copolymer 8, 31.4 g of amine 4 and 10.6 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer O:

In a three-neck flask equipped with stirrer, reflux condenser and gas inlet, 20.0 g of copolymer 8, 15.8 g of amine 4 and 3.9 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer P:

In a three-neck flask equipped with stirrer, reflux condenser and gas inlet, 15.0 g of copolymer 5, 62.7 g of amine 1 and 24.9 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer Q:

In a three-neck flask equipped with stirrer, reflux condenser and gas inlet, 20.0 g of copolymer 5, 31.4 g of amine 1 and 10.6 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer R:

In a three-neck flask equipped with stirrer, reflux condenser and gas inlet, 4.0 g of copolymer 5, 35.8 g of amine 3 and 54.6 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer S:

In a three-neck flask equipped with stirrer, reflux condenser and gas inlet, 20.0 g of copolymer 9, 31.4 g of amine 1 and 10.6 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer T:

In a three-neck flask equipped with stirrer, reflux condenser and gas inlet, 20.0 g of copolymer 10, 27.0 g of amine 4 and 8.7 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer U:

In a three-neck flask equipped with stirrer, reflux condenser and gas inlet, 20.0 g of copolymer 11, 27.0 g of amine 4 and 8.7 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer V:

In a three-neck flask equipped with stirrer, reflux condenser and gas inlet, 20.0 g of copolymer 7, 30.3 g of amine 4 and also 0.20 g of amine 7 and 10.2 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer W:

In a three-neck flask equipped with stirrer, reflux condenser and gas inlet, 20.0 g of copolymer 12, 27.0 g of amine 4 and 8.7 g of 1-methoxy-2-propyl acetate are initially charged and stirred at 80° C. under nitrogen for 60 min. The product is obtained as 70% strength solution of the active substance in 1-methoxy-2-propyl acetate.

Compatibilizer X:

In a three-neck flask equipped with stirrer, reflux condenser and gas inlet, 20.0 g of copolymer 13, 29.0 g of amine 6 and 9.6 g of 1-methoxy-2-propyl acetate are initially charged and stirred at 80° C. under nitrogen for 60 min. The product is obtained as 70% strength solution of the active substance in 1-methoxy-2-propyl acetate.

### Comparative Example (Similar to Example 1 of DE 102008000243)

28.0 g of a polyether monool (butanol started, molecular weight about 1700 g/mol, weight fraction of ethylene oxide units: 0%, weight fraction of propylene oxide units: 100%) were mixed with 36.0 g of a polyether diol (molecular weight about 2000 g/mol, weight fraction of ethylene oxide units: 10%, weight fraction of propylene oxide units: 90%) and 24.0 g of a polyether monool (methanol started, molecular weight about 1000 g/mol, weight fraction of ethylene oxide units: 100%, weight fraction of propylene oxide units: 0%) and admixed with 13.0 g of Desmodur N 3200 (technical grade isocyanate based on HDI-biuret from Bayer MaterialScience AG). Thereafter, 100.0 g of propylene carbonate were added. This mixture was heated to 100° C. and finally admixed with 0.2 g of a 10% strength solution of dibutyltin dilaurate in xylene (catalyst). Stirring was subsequently continued at 100° C. for 4 hours. The product is obtained as a 50% strength solution of the active substance in propylene carbonate.

### II) Performance Testing of Additives

The following polyols were used in the examples:

TABLE II
Polyols used

| Designation | Description |
|---|---|
| PEG-200 | polyethylene glycol 200 |
| PPG-600 | polypropylene glycol 600 |
| Polyol Z | trifunctional high-reactivity polyether |
| | polyol with primary hydroxyl end groups |
| | (OH number = 35) |

Test System 1:

TABLE III
Composition of test system 1 (without added
water)

| Component | Parts by weight |
|---|---|
| Polyol Z | 50 |
| PEG-200 | 25 |
| PPG-600 | 25 |

Procedure for Performing the Separation Test:

100 g of polyol mixture (ratio of polyols as reported in table III) are mixed in a 180 ml beaker. The compatibilizer additive quantity reported in table IV is added in each case. Thereafter, the mixture is homogenized with a dissolver (Pendraulik LD 50, toothed disk: 40 mm diameter, 930 revolutions per minute) for 30 seconds and subsequently transferred into a sealable cylindrical 100 ml glass vessel (diameter: 3.5 cm, height: 14 cm).

Storage takes place at 20° C. in the sealed vessel. After certain time intervals, the mixture is visually examined for onset of separation.

TABLE IV
Separation results in test system 1

| Compatibilizer | Amount of | Observed onset of |
|---|---|---|
| added | compatibilizer* | separation after . . . |
| Blank sample (no | 0 g | 19 h |
| additive) | | |
| A | 2.0 g | 30 h |
| B | 2.0 g | 30 h |
| C | 2.0 g | 41 h |
| D | 2.0 g | 29 h |
| E | 2.0 g | 59 h |
| F | 2.0 g | 88 h |
| G | 2.0 g | 62 h |
| H | 2.0 g | 86 h |
| I | 2.0 g | 89 h |
| J | 2.0 g | 93 h |
| K | 2.0 g | 91 h |
| L | 2.0 g | 86 h |
| M | 2.0 g | 86 h |
| N | 2.0 g | 42 h |
| O | 2.0 g | 42 h |
| P | 2.0 g | 91 h |
| Q | 2.0 g | 91 h |
| R | 2.0 g | 41 h |
| S | 2.0 g | 88 h |
| T | 2.0 g | 89 h |
| U | 2.0 g | 89 h |
| Comparative | 2.8 g | 27 h |
| example | | |

*The amount used of the solution obtained from preparing the particular compatibilizer; therefore, 2.0 g were used of all 70% strength samples (2.0 g of solution contain 1.4 g of active substance) and 2.8 g in the case of the 50% strength sample (2.8 g of solution likewise contain 1.4 g of active substance)

Test System 2:

TABLE V
Composition of test system 2 (with added
water)

| Component | Parts by weight |
|---|---|
| Polyol Z | 50 |
| PEG-200 | 25 |
| PPG-600 | 25 |
| Water | 3 |

Procedure for Performing the Separation Test:

100 g of polyol mixture (ratio of polyols as reported in table V) and 3 g of water are mixed in a 180 ml beaker. The compatibilizer additive quantity reported in table VI is added in each case. Thereafter, the mixture is homogenized with a dissolver (Pendraulik LD 50, toothed disk: 40 mm diameter, 930 revolutions per minute) for 30 seconds and subsequently transferred into a sealable cylindrical 100 ml glass vessel (diameter: 3.5 cm, height: 14 cm).

Storage takes place at 20° C. in the sealed vessel. After certain time intervals, the mixture is visually examined for onset of separation.

TABLE VI
Separation results in test system 2

| Compatibilizer | Amount of | Observed onset of |
|---|---|---|
| added | compatibilizer* | separation after . . . |
| Blank sample (no | 0 g | 2 h |
| additive) | | |
| A | 2.0 g | 10 h |
| B | 2.0 g | 19 h |
| C | 2.0 g | 54 h |
| D | 2.0 g | 26 h |
| E | 2.0 g | 53 h |
| F | 2.0 g | 54 h |
| G | 2.0 g | 50 h |
| H | 2.0 g | 49 h |
| I | 2.0 g | 51 h |
| J | 2.0 g | 49 h |
| K | 2.0 g | 40 h |
| L | 2.0 g | 62 h |
| M | 2.0 g | 63 h |
| N | 2.0 g | 25 h |
| O | 2.0 g | 26 h |
| P | 2.0 g | 50 h |
| Q | 2.0 g | 63 h |
| R | 2.0 g | 19 h |
| S | 2.0 g | 62 h |
| T | 2.0 g | 54 h |
| U | 2.0 g | 53 h |
| Comparative | 2.8 g | 10 h |
| example | | |

*The amount used of the solution obtained from preparing the particular compatibilizer; therefore, 2.0 g were used of all 70% strength samples (2.0 g of solution contain 1.4 g of active substance) and 2.8 g in the case of the 50% strength sample (2.8 g of solution likewise contain 1.4 g of active substance)

Comparing test system 2 with test system 1 shows that the rate of separation changes in the presence of water, but that irrespective of that the separation time of samples that contain the additive is distinctly lengthened versus the blank sample.

1. A storage-stable monophasic liquid composition comprising
(1) 1 to 99 wt % of a first isocyanate-reactive polyol component,
(2) 1 to 99 wt % of at least one second isocyanate-reactive polyol component, said second isocyanate-reactive polyol component (2) being incompatible with said first isocyanate-reactive polyol component (1),
(3) 0 to 45 wt % of at least one further liquid component selected from the group consisting of additives, auxiliary agents, and combinations thereof, and
(4) as compatibilizer additive agent from 0.1 to 10 wt % of at least one copolymer which results in the polyol components (1) and (2) and the optionally present component (3) being monophasical,
wherein the wt % of components (1) to (4) are all based on 100 wt % of the composition and the composition must always total 100 wt % and the sum total of components (1) and (2) must always amount to at least 50 wt % of the composition, and
wherein the copolymer (4) may comprise the following structural units Ito VII and is built of at least one of the structural units I to III, which contain no acidic functional groups, and of at least one of the structural units IV to VII, which contain at least one acidic functional group, and the copolymer (4) has a molar ratio of acidic functional groups to optionally present N-containing, basic groups and/or corresponding quaternized groups of the unsalted copolymer (4) of at least 5:1: 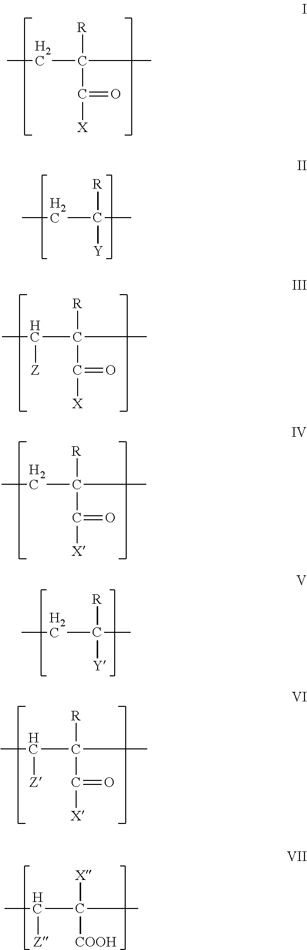
where
R, which is the same or different in each occurrence, represents hydrogen or an optionally branched alkyl moiety of 1-5 carbon atoms,
X, which is the same or different in each occurrence, represents an —OR¹ group, an 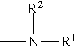
group or an —NH₂ group, where
R¹, which is the same or different in each occurrence, represents an optionally branched alkyl moiety of 1-12 carbon atoms, an optionally branched alkenyl moiety of 1-12 carbon atoms, which optionally may contain functional groups with the exception of acidic functional groups, a cycloalkyl moiety of 4-10 carbon atoms, an aromatic moiety of 6-20 carbon atoms, wherein each of these moieties may optionally also be substituted, but does not contain an acidic functional group, a polyether moiety or a polyester moiety or a polyether/polyester moiety, which each does not contain any acidic groups,
R², which is the same or different in each occurrence, represents hydrogen or has the meaning of R¹,
Y represents an optionally substituted, aromatic moiety of 4-12 carbon atoms which optionally has at least one heteroatom as ring member, a lactam moiety of 4-8 carbon atoms, a polyether or polyester moiety attached via an —O— or 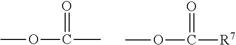
bridge, or an group, where
R⁷ represents an alkyl moiety of 1-6 carbon atoms or a cycloalkyl moiety of 4-10 carbon atoms, wherein each of these moieties may be substituted with functional groups with the exception of acidic functional groups,
Z represents a —COOR¹ group, where R¹ is as defined above, or
Z combines with the 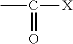
group where X is an 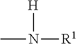
or —NH₂ group to form a cyclic imide group whose nitrogen may optionally be substituted with an R¹ moiety as defined above,
X′, which is the same or different in each occurrence, represents an —OH group which is optionally present as a group salted by salting with one of the hereinafter recited, optionally organic, basic compounds (5) used for salting, or
represents an —OR¹¹ group or a 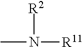
group,
where
R¹¹, which is the same or different in each occurrence, represents an optionally branched alkyl moiety of 1-20 carbon atoms, an optionally branched alkenyl moiety of 1-20 carbon atoms, a cycloalkyl moiety of 4-10 carbon atoms, an aromatic moiety, wherein each of these moieties in addition to at least one of the hereinafter recited acid groups may optionally be further substituted,
and R² is as defined above,
a polyether moiety, a polyester moiety or a polyether/polyester moiety,
wherein each of these moieties contains at least one carboxylic, sulfonic, phosphonic and/or phosphoric acid group which optionally by salting with one of the hereinafter recited, preferably organic, basic compounds (5) used for salting is present as salted group;
Y′ represents a phosphonic acid group, phosphoric acid group, represents a linear or branched aliphatic radical of 1 to 8 carbon atoms, represents an aromatic radical of at least 5 ring members which optionally contains heteroatoms, or represents a saturated or unsaturated cycloaliphatic radical of at least 5 ring members which optionally contains heteroatoms, wherein each of these radicals contains at least one carboxylic, sulfonic, phosphonic and/or phosphoric acid group, wherein the acidic group is optionally through salting with one of the hereinafter recited, preferably organic, basic compounds (5) used for salting present as salted group, or
represents a polyether or polyester moiety attached via an —O— or 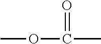
bridge or a 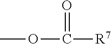
group, where
R⁷ represents an optionally substituted branched or unbranched alkyl moiety of 1-6 carbon atoms or an optionally substituted cycloalkyl moiety of 4-10 carbon atoms, wherein each of the polyether or polyester moieties or each of the R⁷ moieties contains at least one carboxylic, sulfonic, phosphonic and/or phosphoric acid group which optionally by salting with one of the hereinafter recited, preferably organic, basic compounds (5) used for salting is present as salted group;
Z′, which is the same as or different from X′, represents a grouping having the meaning of X′, represents a —COON group or represents a —COOR¹ group or a —COOR¹¹ group, where R¹ and —R¹¹, which are the same or different, are each as defined before,
Z″ represents hydrogen, an optionally branched alkyl moiety of 1-10 carbon atoms or an aryl moiety of 6-20 carbon atoms, wherein each of these moieties may be substituted with a carboxyl group,
X″, which is the same as or different from Z″, has the meaning of Z″, in which case either only Z″ or X″ can have the meaning of hydrogen,
wherein the structural units IV to VII are optionally at least partly present in salted form by reaction with at least one optionally oligomeric, optionally organic compound (5) having at least one basic group as salting compound.

2. A composition according to claim 1, characterized in that wherein the first isocyanate-reactive polyol component (1) is at least one short-chain polyol, optionally an aliphatic polyol having 2-8 carbon atoms and at least two hydroxyl groups, or at least one polyether polyol, polyester polyol and/or a polyether-polyester polyol each with at least two terminal hydroxyl groups, and the second isocyanate-reactive polyol component (2) is different than the first isocyanate-reactive polyol component (1) and is at least one polyether polyol, at least one polyester polyol, at least one polybutadiene polyol and/or at least one polyether-polyester polyol each with at least two terminal hydroxyl groups.

3. A composition according to claim 1, wherein, in the structural units I-VII,
R, which is the same or different in each occurrence, represents hydrogen, methyl or ethyl,
X, which is the same or different in each occurrence, represents an —NN—R¹ group or an —OR¹ group, where R¹, which is the same or different, represents an optionally branched alkyl moiety of 1 to 8 carbon atoms, a benzyl moiety, an optionally branched alkylene moiety of 1 to 8 carbon atoms, optionally substituted with an OH group, which is optionally present as end group, or a polyalkylene oxide moiety, wherein each of these moieties does not contain any acidic functional groups,
Y represents an optionally substituted phenyl, naphthyl or pyrrolidone moiety, an ε-caprolactam moiety, a polyalkylene oxide moiety attached via an —O— bridge or an acetate moiety, wherein each of these moieties does not contain any acidic functional groups,
Z represents a —COOR¹ group, where R¹, which is the same or different in each occurrence, is as defined above, or
Z combines with the 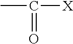
group where X is an 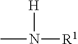
group to form a cyclic imide grouping whose nitrogen is substituted with an R¹ moiety, which is the same or different, as defined above,
X′, which may be the same or different in each occurrence, represents an —OH group which is optionally present as a group salted by salting with at least one of the hereinafter recited, optionally organic, basic compounds (5), or
represents an —OR¹¹ group,
where
R¹¹ represents an optionally branched alkyl moiety or alkylene moiety of 1 to 16 carbon atoms, which contains at least one carboxylic, sulfonic, phosphonic and/or phosphoric acid group which optionally through salting with at least one of the hereinafter recited, optionally organic, basic compounds (5) is present as salted group,
Y′ represents a phosphonic acid group, phosphoric acid group, represents a linear or branched aliphatic radical of 1 to 8 carbon atoms or aromatic radical of at least 6 carbon atoms, wherein each radical contains at least one carboxylic, sulfonic, phosphonic and/or phosphoric acid group which optionally through salting with at least one of the hereinafter recited, preferably organic, basic compounds (5) is present as salted group,
Z′, which is the same as or different from X′, represents a grouping having the meaning of X′, represents a —COON group or represents a —COOR¹ group, where R¹, which is the same or different, is as defined above,
Z″ represents hydrogen, an optionally branched alkyl moiety of 1-6 carbon atoms or an aryl moiety of 6-10 carbon atoms, wherein each of the moieties may be substituted with a carboxyl group,
X″, which is the same as or different from Z″, has the meaning of Z″, in which case either only Z″ or only X″ can have the meaning of hydrogen,
wherein the structural units IV to VII are optionally at least partly present in salted form by reaction with at least one optionally oligomeric, optionally organic compound (5) having at least one basic group as salting compound.

4. A composition according to claim 1, wherein in said at least one copolymer (4) the molar ratio of acidic functional groups to optionally present N-containing, basic groups and/or corresponding quaternized groups of the unsalted copolymer (4) is at least 10:1 and preferably optionally at least 20:1.

5. A composition according to the proportion of structural units IV-VII before any salting is from 5 to 95 wt %, based on the total weight of structural units I-VII of copolymer (4).

6. A composition according to claim 1, wherein the copolymer (4) has a number-averaged molecular weight in the range from 600 to 250 000 g/mol in the unsalted form.

7. A composition according to claim 1, wherein the copolymer (4) is a structured copolymer which optionally has a blocklike or gradientlike, optionally branched or star-shaped arrangement of copolymerized structural units which optionally comprises comb structures.

8. A composition according to claim 7, wherein copolymer (4) is a block copolymer, which optionally also includes branching sites in the polymer chain.

9. A composition according to claim 7 wherein in two adjacent blocks the proportion of structural units IV-VII differs by at least 5 wt %, based on the total amount of the particular block.

10. A composition according to claim 1, wherein the copolymer (4) is produced by a controlled free-radical polymerization or an ionic polymerization.

11. A composition according to claim 1, wherein the structural units I-III of copolymer (4) are obtained by polymerization of ethylenically unsaturated monomers selected from the group consisting of (meth)acrylic esters, which optionally have functional groups such as selected from the group consisting of OH, halogen, lactone, epoxy groups and combinations thereof or derive from polyethers, optionally (meth)acrylamides, optionally substituted styrene, substituted maleic anhydride and maleic acid diesters, maleimides, vinyl-containing, non-basic cycloaliphatic heterocycles having at least one nitrogen atom as ring member, and vinyl esters of carboxylic acids, wherein none of the monomers contains an acidic functional group.

12. A composition according to claim 1, wherein the structural units IV-VII of copolymer (4) are produced by polymerization of ethylenically unsaturated monomers selected from the group consisting of (i) ethylenically unsaturated aliphatic monomers having acidic functional groups, and (ii) monomers having a C═C double bond and at least one deprotonatable group and optionally containing aromatic moieties.

13. A composition according to claim 1, wherein basic compound (5) comprises aliphatic and aromatic primary, secondary and tertiary amines, which may optionally each be substituted with hydroxyl groups and/or alkoxy groups, and/or at least one polyether which is based on alkylene oxide, styrene oxide or tetrahydrofuran and has at least one amino end group and, and/or at least one compound selected from the group consisting of alkoxylated, saturated or unsaturated primary and secondary amines of 1-24 carbon atoms.

14. A composition according to claim 1, wherein the copolymer is in liquid form.

15. A composition according to claim 1, wherein at least 5 mol % of the structural units having acidic functional groups are in salted form.

16. A composition according to claim 1, wherein, by way of auxiliary and admixture agents (3) there are present in liquid form at least one compound selected from the group consisting of catalysts, accelerants, chain extenders, foaming agents, chain crosslinkers, foam stabilizers, antifoams, deaerators, viscosity reducers, thixotropic agents, heat stabilizers, flame retardants, oxidation inhibitors, dyes, wetting and dispersing agents, process additives, adhesion promoters, blowing agents, plasticizers, antistats, stabilizers, release agents, process additives, water and solvents.

17. A composition according to claim 1, wherein the proportion of component (1) is from 10 to 90 wt %, the proportion of component (2) is from 10 to 90 wt %, the proportion of component (3) is from 0.1 to 25 wt % and the proportion of copolymer (4) is from 0.25 to 7.5 wt %, all based on 100 wt % of the composition, wherein the total amount of the composition must always add up to 100 wt % and the proportion of components (1) to (4) is at least 80 wt %.

18. A composition according to claim 17, wherein the proportion of copolymer (4) is from 0.5 to 4 wt %, based on 100 wt % of the composition.

19. A method for producing foamed or unfoamed Polyurethanes, which comprises producing said foamed or unfoamed polyurethanes from the composition of claim 1, optionally after addition of at least one further additive and auxiliary agent in solid form selected from the group consisting of flame retardants, antistats, pigments and organic or inorganic fillers, optionally in fiber form.

20. A foamed or unfoamed polyurethane article obtainable obtained by reacting the composition of claim 1 with at least one organic polyisocyanate component.
